(19) United States
(12) Patent Application Publication
(10) Pub. No.: US 2026/0064241 A1
(43) Pub. Date: Mar. 5, 2026

(54) METHODS AND APPARATUSES FOR PROVIDING USER INTERFACE ALLOWING USER TO INPUT CONTENTS WITH RESPECT TO VIDEO AND 3 DIMENSIONAL MAP DISPLAYED IN AUGMENTED REALITY VIEW

(71) Applicant: NAVER CORPORATION, Seongnam-si, (KR)

(72) Inventors: Jeanie JUNG, Seongnam-si (KR); Sangwook KIM, Seongnam-si (KR); Jongjin PARK, Seongnam-si (KR)

(73) Assignee: NAVER CORPORATION, Seongnam-si, (KR)

(21) Appl. No.: 19/383,038

(22) Filed: Nov. 7, 2025

Related U.S. Application Data
(63) Continuation of application No. PCT/KR2024/000599, filed on May 3, 2024.

(30) Foreign Application Priority Data
May 9, 2023 (KR) 10-2023-0059944

(51) Int. Cl. G06F 3/04815; G01C 21/36; G06F 3/04845; G06T 17/05; G06T 19/00

(52) U.S. Cl. CPC G06F 3/04815; G01C 21/3635; G06F 3/04845; G06T 17/05; G06T 19/006; G06T 2200/24

(57) ABSTRACT

Provided is a method of controlling a user terminal including providing a first User Interface (UI) for inputting first content created by a user of the user terminal at a first location selected within a video of an Augmented Reality (AR) view that includes a video captured by a camera of the user terminal, or providing a second UI for inputting second content created by the user at a second location selected within a three-dimensional (3D) map that is augmented and displayed in the video within the AR view, and if the first content is input, outputting first corresponding content corresponding to the first content in the 3D map when the 3D map including the first location is displayed within the AR view, or if the second content is input, outputting second corresponding content corresponding to the second content in the video of the AR view including the second location.

### CROSS-REFERENCE TO RELATED APPLICATION(S)

This U.S. non-provisional application is a continuation of International Application No. PCT/KR2024/005991, which has an international filing date of May 3, 2024, and claims priority under 35 U.S.C. § 119 to Korean Patent Application No. 10-2023-0059944, filed on May 9, 2023, in the Korean intellectual property office, the disclosures of each of which are herein incorporated by reference in their entirety.

### BACKGROUND

### Technical Field

Some example embodiments of the following description relate to a method and apparatus for providing a user interface that allows a user to input content for a video/three-dimensional (3D) map displayed within an Augmented Reality (AR) view, and reflecting and displaying the content input through the user interface (e.g., displaying corresponding content) in the 3D map/video displayed within the AR view.

### Description of Related Art

Augmented Reality (AR) refers to technology that converges and supplements a virtual object and information created using computer technology with the real world. That is, augmented reality refers to technology that augments and thereby displays virtual content in a real-world environment, and a user may view the augmented content corresponding to the real-world environment through an electronic device.

A three-dimensional (3D) map is constructed by three-dimensionally modeling an actual space or environment, and is provided to the user through a separate application that provides services using this 3D map. An example of this 3D map is S-MAP that is constructed by modeling the entire city of Seoul as 3D virtual reality. The 3D map may be used to provide the user with the same experience as (or a similar experience to) the user visiting a corresponding location although the user does not visit an actual location indicated on the map. The user utilizes this 3D map to virtually map a specific area or to establish a policy for safety, environment, and urban planning for the corresponding area.

As technology related to various services that utilize augmented reality technology, for example, an augmented reality navigator may be installed in a vehicle to display a video of a driving route captured by a camera on a display and to map virtual display information of guiding based on the driving route onto the video displayed on the display.

The aforementioned information is simply provided to help understanding, and may not include the content that does not form a portion of the related art and may not include what the related art may suggest to a person skilled in the art.

### SUMMARY

Some example embodiments provide a more immersive experience to a user and more effectively provides the user with information on objects (e.g., land features) displayed through a 3D map.

Some example embodiments may provide a method of controlling a user terminal to provide a user interface that allows a user to input content for a video displayed within an augmented reality (AR) view and to display corresponding content by reflecting the content input through the user interface in a three-dimensional (3D) map displayed within the AR view.

Some example embodiments may provide a method of controlling a user terminal to provide a user interface that allows a user to input content for a 3D map displayed within an AR view, and to display corresponding content by reflecting the content input through the user interface in a video of the AR view.

Some example embodiments may provide a method of inputting an action to be executed by a user terminal as content at a specific location of a 3D map, and executing, by the user terminal, the action when the specific location is included in the AR view (e.g., when the user terminal moves to the specific location).

According to some example embodiments, there is provided a method of controlling a user terminal, performed by a computer system that is a server or the user terminal, the method including providing a first User Interface (UI) for inputting first content created by a user of the user terminal at a first location selected within a video of an Augmented Reality (AR) view that includes a video captured by a camera of the user terminal, or providing a second UI for inputting second content created by the user at a second location selected within a three-dimensional (3D) map that is augmented and displayed in the video within the AR view, and if the first content is input by the user through the first UI, reflecting and first outputting first corresponding content corresponding to the first content in the 3D map when the 3D map that includes the first location is displayed within the AR view, or if the second content is input by the user through the second UI, reflecting and second outputting second corresponding content corresponding to the second content in the video of the AR view that includes the second location.

In a case in which the first UI is provided and the first content is input at the first location, the method of controlling the user terminal may further include displaying the 3D map that includes the first location within the AR view according to a location of the user terminal or a request from the user of the user terminal, and the first outputting may include outputting the first corresponding content in association with the first location within the 3D map that includes the first location.

The first content may include at least one of audio, text, or an image, and the first outputting of the first corresponding content may include at least one of playback of the audio, displaying of the text, or displaying of the image.

The 3D map that includes the first location may be displayed on another user terminal according to a location of the other user terminal or a request from a user of the other user terminal, and the first corresponding content may be output in association with the first location within the 3D map displayed on the other user terminal.

The first location may correspond to a Point of Interest (POI) selected from among POIs displayed in the video, and the first content may be input in association with the selected POI.

The first location may be a starting point of a route through which the user terminal moves, the first content may include information on the route from the starting point to a predetermined destination, and the first outputting may include displaying the route from the starting point to the predetermined destination within the 3D map that includes the first location.

The method of controlling the user terminal may further include displaying the 3D map that includes the second location within the AR view according to a location of the user terminal or a request from a user of the user terminal, the second content may be input in association with the second location through the second UI, and the second outputting may include outputting the second corresponding content in association with the second location in the video of the AR view when the second location is included in the video of the AR view.

The 3D map that includes the second location may be displayed within the AR view as a mini map of an area that includes the second location.

The second content may include at least one of audio, text, or an image, and the second outputting of the second corresponding content may include at least one of playback of the audio, displaying of the text, or displaying of the image.

The second content may include a predetermined action to be executed by the user terminal, and the second outputting may include executing the predetermined action on the user terminal when the second location is included in the video of the AR view.

The executing of the predetermined action may include providing route guidance from a first point corresponding to the second location to a second point, starting recording of the AR view, interacting with an Internet of Things (IoT) device provided in association with the second location, calling a specific contact of the user terminal, or providing real-time information associated with the second location.

The real-time information may include at least one of weather information, traffic information, or air quality information of an area associated with the second location.

The predetermined action corresponding to the providing of the real-time information may be executed when a time at which the second location is included in the video of the AR view belongs to a preset time zone.

The interacting with the IoT device may include a task of calling a specific person through the IoT device.

The second location may include a starting point of a route designated on the 3D map that includes the second location, the second content may include information on the route from the starting point to a predetermined destination, and the second outputting may include providing guidance for the route from the starting point corresponding to the second location to the predetermined destination, within the video of the AR view.

At least a portion of the route may be designated by the user of the user terminal on the 3D map that includes the second location.

The 3D map that includes the second location may be displayed on the user terminal such that the user of the user terminal virtually explores an area that includes the second location, and at least a portion of the route may be an automatically recorded route that is virtually explored by the user on the 3D map that includes the second location.

The second location may correspond to a Point of Interest (POI) selected from among POIs displayed on the 3D map that includes the second location, or the second location may correspond to a selected location on an object displayed on the 3D map that includes the second location, and the second content may be input in association with the selected POI or the selected location.

The method of controlling the user terminal may further include providing a third UI for inputting additional content to the second corresponding content that is output in association with the second location within the video of the AR view, and if the additional content is input through the third UI, outputting the additional content in association with the second content at the second location of the 3D map that includes the second location when displaying the 3D map that includes the second location.

The method of controlling the user terminal may further include transmitting the first content input through the first UI to a cloud server together with 6 degree of freedom (6DoF) information of the first location, or transmitting the second content input through the second UI to the cloud server together with 6DoF information of the second location.

According to some example embodiments, there is provided a computer system that implements a user terminal or a server, the computer system including at least one processor configured to execute computer-readable instructions included in a memory, wherein the at least one processor is configured to display an AR view that includes a video captured by a camera of the user terminal, to provide a first UI for inputting first content at a first location selected in the video or provide a second UI for inputting second content at a second location selected in a 3D map that is augmented and displayed in the video within the AR view, and to if the first content is input through the first UI, output first corresponding content corresponding to the first content when the 3D map that includes the first location is displayed within the AR view, or to if the second content is input through the second UI, output second corresponding content corresponding to the second content in the video of the AR view that includes the second location.

According to some example embodiments, there is provided a method of controlling a user terminal, performed by a computer system that is a server or the user terminal, the method including displaying a 3D map of an area including a first location that is a location of the user terminal or a location designated by a user; providing a first UI for inputting content at a second location selected within the 3D map; if the content is input through the first UI, outputting corresponding content corresponding to the content in association with the second location within a video of an AR view when the second location is included in the AR view that includes the video captured by a camera of the user terminal; providing a second UI for inputting additional content for the output corresponding content; and, if the additional content is input through the second UI, outputting the additional content in association with the content at the second location of the 3D map when displaying the 3D map.

According to some example embodiments, by reflecting and displaying content input (created) by a user for a video/3D map displayed within an AR view in the 3D map/video displayed within the AR view, it is possible to improve usability of the AR view and the 3D map displayed in the AR view. That is, a user that uses the AR view and the 3D map proposed herein may perform verification or validation through the AR view at an actual location for a location specified in the 3D map that requires verification or validation. Also, this user may organize notes or check items through the AR view while moving through a predetermined (or alternatively, given) area, through a 3D map that represents the area.

In response to content that includes an image, text, etc., or an action to be executed by the user terminal being input at a specific location of the 3D map, when the specific location is included in the AR view (e.g., when the user terminal moves to the specific location), the corresponding content may be output on the user terminal, or various actions, such as route guidance, AR view recording, and provision of real-time information, may be executed. That is, when content is input at the specific location of the 3D map, the user moves to the specific location, and the AR view is executed, the content may be output at the corresponding location (specific location at which content is input) within the AR view. Therefore, the user may input content indicating items to be verified in association with the specific location without directly visiting the specific location. When the user actually moves to the location, content may be output at a location corresponding to the specific location of the AR view according to positioning of the user terminal. The location at which the content is input on the 3D map and the location within the AR view determined according to positioning may be linked (or synchronized).

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Some example embodiments will be described in more detail with regard to the figures, wherein like reference numerals refer to like parts throughout the various figures unless otherwise specified, and wherein:

FIG. 1 illustrates a method of displaying a three-dimensional (3D) map within an Augmented Reality (AR) view and outputting content related to an object within the 3D map according to some example embodiments;

FIG. 2 is a diagram illustrating a computer system and a server that execute an AR view, display a 3D map within the AR view, and output content according to some example embodiments;

FIG. 3 is a flowchart illustrating a method of controlling a user terminal to display a 3D map within an AR view, and to output content related to an object within the 3D map according to some example embodiments;

FIG. 4 is a flowchart illustrating a method of controlling a user terminal when information that describes a second object on a 3D map is output from the content including information that describes a first object within the 3D map according to an example;

FIG. 5 is a flowchart illustrating a method of controlling a user terminal when information that describes a third object outside a 3D map is output from the content including information that describes a first object within the 3D map according to an example;

FIG. 6 is a flowchart illustrating a method of outputting property information registered in association with real estate within an AR view when an object within a 3D map is real estate according to an example;

FIG. 7 illustrates content including information that describes a first object within a 3D map according to an example;

FIGS. 8 to 14 illustrate a method of displaying a 3D map within an AR view and outputting content related to an object within the 3D map according to an example;

FIG. 15 illustrates a method of outputting property information registered in association with real estate within an AR view according to an example;

FIG. 16 illustrates objects and points of interest (POIs) included in a 3D map displayed within an AR view according to an example;

FIG. 17 illustrates a method of displaying a 3D map within an AR view such that the orientation of the AR view matches the orientation of the 3D map based on orientation information of the AR view according to some example embodiments;

FIG. 18 is a flowchart illustrating a method of controlling a user terminal to display a 3D map within an AR view such that the orientation of the AR view matches the orientation of the 3D map, and to further display additional information on an external area outside the 3D map according to some example embodiments;

FIG. 19 is a flowchart illustrating a method of displaying additional content or a two-dimensional (2D) map as additional information on an external area outside a 3D map according to an example;

FIG. 20 illustrates a method of matching coordinates of a 3D map and coordinates of a 2D map representing an area of the 3D map and an external area thereof according to an example;

FIGS. 21 to 23 illustrate a method of displaying a 2D map in an external area outside a 3D map within an AR view according to an example;

FIG. 24 illustrates a method of displaying POI information as additional content in an external area outside a 3D map within an AR view according to an example;

FIG. 25 is a flowchart illustrating a method of controlling a user terminal to input first content in an AR view and output first corresponding content corresponding to the first content in a 3D map, or to input second content in the 3D map and output second corresponding content corresponding to the second content in the AR view according to some example embodiments;

FIG. 26 is a flowchart illustrating a method of controlling a user terminal to input first content in an AR view and output first corresponding content corresponding to the first content in a 3D map according to an example;

FIG. 27 is a flowchart illustrating a method of controlling a user terminal to input second content in a 3D map and output second corresponding content corresponding to the second content in an AR view according to an example;

FIG. 28 illustrates a method of verifying (or confirming) content created at a specific location of a 3D map in an AR view including the specific location, and reflecting the content verified (or confirmed) in the AR view to the 3D map according to an example;

FIG. 29 illustrates a method of inputting an action to be executed by a user terminal as second content at a specific location of a 3D map and allowing the user terminal to execute the action when the specific location is included in an AR view according to an example;

FIG. 30 illustrates a method of displaying a 3D map including a current location of a user terminal within an AR view that includes a video captured at the current location according to an example; and

FIG. 31 illustrates a method for a user terminal to guide an input route when the route is input as second content at a specific location of a 3D map and the specific location is included in an AR view according to an example.

### DETAILED DESCRIPTION

Hereinafter, some example embodiments will be described in detail with reference to the accompanying drawings.

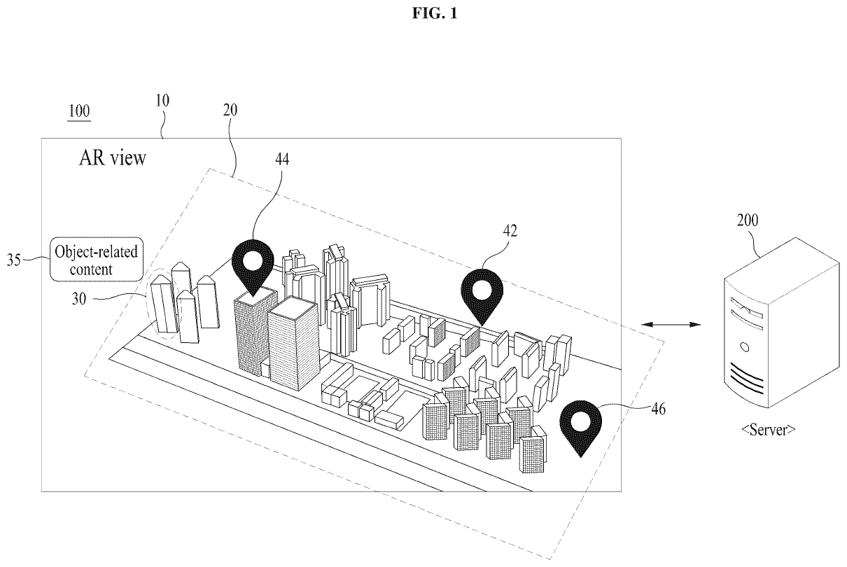

FIG. 1 illustrates a method of displaying a three-dimensional (3D) map within an Augmented Reality (AR) view and outputting content related to an object within the 3D map according to some example embodiments.

In some example embodiments to be described below, as illustrated in FIG. 1 “control” of a user terminal 100 may include, for example, at least one of augmenting and display content that represents a specific service or information in a video of an AR view 10 using the AR view 10 of the user terminal 100; displaying a User Interface (UI) related to the specific service on the user terminal 100; displaying a 3D map 20 of an area that includes a location of the user terminal 100 or a location designated by a user of the user terminal 100 within the AR view 10 and outputting contents 35 and 42, 44 and 46 in the 3D map 20; and controlling settings of the user terminal 100 to provide a specific service in the user terminal 100. Also, “control” of the user terminal 100 in some example embodiments may include controlling functions and/or operations of the user terminal 100, which are not limited to the examples. At least a portion of the control of the user terminal 100 may be performed by an illustrated server 200.

In the following detailed description, a location of the user terminal 100 may indicate a location of the user possessing the user terminal 100. Also, for clarity of description, the terms “user” and “user terminal 100” possessed by the user may be interchangeably used.

In the following detailed description, “augmenting and displaying” content and/or information (e.g., indicator) on a video may be interpreted to encompass overlappingly displaying the content and/or information on the video/screen of the AR view 10 depending on some example embodiments. “Augmented content” displayed on the AR view 10 may also be referred to “AR content.”

In FIG. 1, the screen of the user terminal 100 is indicated as the user terminal 100 for clarity of description.

For example, the user terminal 100, such as a smartphone, may capture a video of surroundings using a camera and may display, on the screen, the AR view 10 that includes the video captured by the camera. The user terminal 100 may display the 3D map 20 of the area that includes the location of the user terminal 100 or the location designated by the user of the user terminal 100, through augmentation in the video in at least a partial area of the AR view 10, that is, within the AR view 10. According to some example embodiments, the camera may include a plurality of light sensors (e.g., photodiodes) arranged in a grid (e.g., pixels). The plurality of light sensors may each generate a signal (e.g., a current) in response to receiving light (e.g., photons) that collides with one or more among the plurality of light sensors after reflecting off of an object (e.g., a subject of an image). According to some example embodiments, the signal may be proportional to an intensity of the light received by a given light sensor. According to some example embodiments, the user terminal 100 may convert the signals generated by each among the plurality of light sensors into an image based on respective positions of the plurality of lights sensors in the grid. The above-described operations of the camera may be performed continuously to generate a time series of images (e.g., the video). The user terminal 100 may display the video on the screen in real-time along with AR content superimposed thereon to provide the AR view 10.

That is, the 3D map 20 of a certain area may be augmented and displayed in the proposed AR view 10. As illustrated, the 3D map 20 may be displayed in a partial area of the AR view 10 by being augmented in the video of the AR view 10 (portion other than the 3D map 20 of the AR view 10 in FIG. 1). Alternatively, the 3D map 20 may be displayed in the entire area of the AR view 10. The scale of the 3D map 20 may be adjusted (e.g., zoomed in or zoomed out) in response to manipulation on the user terminal 100. Therefore, the user of the user terminal 100 may acquire information on the area represented by the 3D map 20 through the 3D map 20. According to some example embodiments, augmentation as described herein may refer to replacement of a subportion of pixels of the video with other graphical data (e.g., the AR content, the 3D map 20, etc.). For example, the other graphical data may be stored in connection with a corresponding layout specifying the particular pixels of the screen on which the other graphical data is to be displayed. The user terminal 100 may augment the video by replacing, on a pixel-by-pixel basis, pixels of the video specified in the layout as corresponding to the other graphical data, thereby presenting the AR view 10 on the screen in which the other graphical data (e.g., the AR content, the 3D map 20, etc.) appears to be superimposed on the video. While discussed here with reference to augmenting the video to include the AR content and/or the 3D map 20, this same process (or a similar process) may be used (e.g., by the user terminal 100) to augment the video to include any other graphical data described herein as being included in the AR view 10 (e.g., the orientation, etc.).

The 3D map 20 displayed in the AR view 10 is augmented in space through AR and may provide the user with an immersive experience related to the area represented by the 3D map 20. For example, the user may have an experience as if the user is actually in the area represented by the 3D map 20 through the 3D map 20 (in a state in which the 3D map 20 is displayed in a sufficiently enlarged manner within the AR view 10). As the user terminal 100 moves with the user, displaying of the 3D map 20 may also change accordingly. Therefore, the user may virtually experience or explore the area represented by the 3D map 20. Alternatively, the 3D map 20 may provide a function that allows the user to virtually experience or explore the area represented by the 3D map 20 in a manner similar to a street view or a street view service (e.g., a method of using a screen touch). For example, the user may utilize the proposed AR view 10 and 3D map 20 to virtually visit the area represented by the 3D map 20 or to plan a trip to the area.

The 3D map 20 may be a 3D model of land features that are actually present in the area. The land features refer to any natural or artificial object present on the ground, for example, buildings, trees, houses, rivers, and roads. The 3D map 20 may include a plurality of objects, and each of the objects may represent at least one of the land features.

In some example embodiments, the user terminal 100 may output content (35, 42, 44 and 46) that includes information related to a first object 30, based on the user's interaction with the first object 30 within the 3D map 20. Content output in the user terminal 100 may be performed in a visual and/or auditory form. For example, if a specific “building” is selected as the first object 30 within the 3D map 20, the user terminal 100 may output the content 35 that includes information related to the building, or may further output the content 42, 44 and 46 related to other objects required (or otherwise, used) to explain the building.

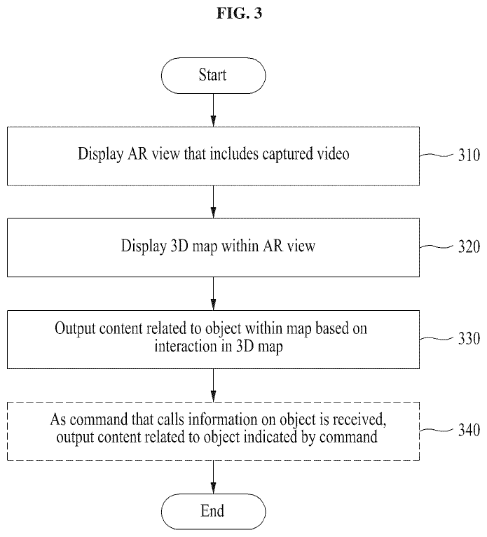

A method of outputting, by the user terminal 100, the content (35, 42, 44 and 46) based on the interaction with the first object 30 is further described with reference to FIGS. 3 to 16 below.

The 3D map 20 may be extracted from a wide-area 3D map for an environment (wide area) that includes the area represented by the 3D map 20. According to some example embodiments, the 3D map 20 may represent a subportion of the wide-area 3D map. This wide-area 3D map may be provided through an external service (e.g., S-map, Google Earth, Apple maps, etc.).

As described above, in some example embodiments, in the AR view 10 provided through the user terminal 100, not only the video but also the 3D map 20 of the area that includes the location of the user terminal 100 or the location designated by the user of the user terminal 100 may be displayed, and as the interaction with the first object 30 included in the 3D map 20 is performed, content that includes information related to the first object 30 may be output.

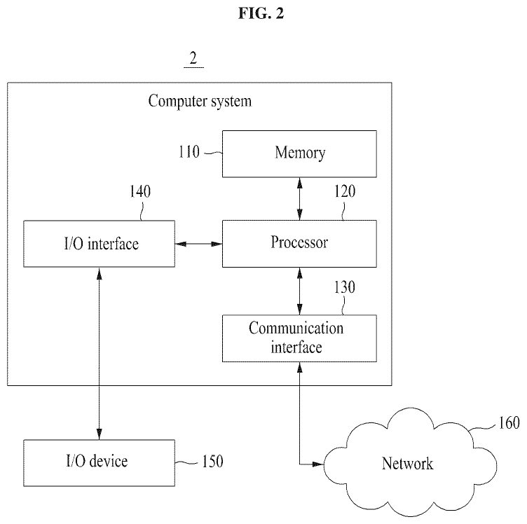

FIG. 2 illustrates a computer system that performs a method of controlling a user terminal according to some example embodiments.

The user terminal 100 described above with reference to FIG. 1 according to some example embodiments may be implemented through an illustrated computer system 2. For example, a computer program for implementing the proposed method may be installed and running on the computer system 2, and the computer system 2 may perform a method of controlling the user terminal 100 according to some example embodiments under control of the running computer program.

The method of controlling the user terminal 100 according to some example embodiments may be performed through a Personal Computer (PC)-based program or an application dedicated for a mobile terminal. For example, the method of controlling the user terminal 100 according to some example embodiments may be implemented in the form of an independently operating program, or may be implemented in an in-app form of a specific application to be operable on the specific application. The specific application may be, for example, installed on the computer system 2 and may perform the proposed method of controlling the user terminal 100 by displaying the 3D map 20 through the AR view 10 and by outputting the content (35, 42, 44 and 46).

The computer system 2 may be an electronic device corresponding to the aforementioned user terminal 100, and/or may be a smartphone that may install and execute the application or the program of FIG. 1 or a device similar thereto. Additionally or alternatively, the computer system 2 may be a Personal Computer (PC), a notebook computer, a laptop computer, a tablet, an Internet of things (IoT) device, a mobile device, a wireless device, a User Equipment (UE), a wearable computer, etc.

As illustrated, the computer system 2 may include a memory 110, a processor 120, a communication interface 130, and/or an Input/Output (I/O) interface 140 as components for performing the method of controlling the user terminal 100. According to some example embodiments, operations described herein as being performed by the user terminal 100, the computer system 2, the processor 120, the communication interface 130, the I/O interface 140 and/or the server 200 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a Central Processing Unit (CPU), an Arithmetic Logic Unit (ALU), a Graphics Processing Unit (GPU), a digital signal processor, a microcomputer, a Field Programmable Gate Array (FPGA), a System-on-Chip (SoC), a programmable logic unit, a microprocessor, Application-Specific Integrated Circuit (ASIC), etc.

The memory 110 may include a permanent mass storage device, such as a Random Access Memory (RAM), a Read Only Memory (ROM), a disk drive, etc., as a non-transitory computer-readable recording medium. The permanent mass storage device, such as a ROM and/or a disk drive, may be included in the computer system 2 as a permanent storage device separate from the memory 110. Also, an Operating System (OS) and at least one program code may be stored in the memory 110. Such software components may be loaded to the memory 110 from another non-transitory computer-readable recording medium separate from the memory 110. The other non-transitory computer-readable recording medium may include, for example, a floppy drive, a disk, a tape, a DVD/CD-ROM drive, a memory card, etc. According to some example embodiments, software components may be loaded to the memory 110 through the communication interface 130, instead of the non-transitory computer-readable recording medium. For example, the software components may be loaded to the memory 110 of the computer system 2 based on a computer program installed by files received over a network 160.

According to some example embodiments, the network 160 may be a wireless communication network (e.g., between the user terminal 100 and the server 200). Such a wireless communication network may support communication between multiple users by sharing available network resources. For example, in the wireless communication network, information may be transmitted in various multiple access schemes, such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), OFDM-FDMA, OFDM-TDMA, and OFDM-CDMA. In some example embodiments, the user terminal 100 may communicate with other user terminals through a sidelink, such as device-to-device (D2D).

The processor 120 may be configured to process instructions of a computer program by performing basic arithmetic operations, logic operations, and I/O operations. The computer-readable instructions may be provided from the memory 110 or the communication interface 130 to the processor 120. For example, the processor 120 may be configured to execute received instructions in response to the program code stored in the storage device, such as the memory 110.

That is, the processor 120 may manage the components of the computer system 2, and may execute a program or an application used by the computer system 2. For example, the processor 120 may be configured to execute the application for performing the proposed method of controlling the user terminal 100, and to process data received from the server 200 to control the user terminal 100 (e.g., data received from the server 200 to display the 3D map 20 through the AR view 10, and to output the content (35, 42, 44 and 46)). Also, the processor 120 may process an operation required (or otherwise, used) for executing the program or the application and processing the data, and may be at least one processor of the computer system 2 or at least one core within the processor.

The communication interface 130 may provide a function for communication between the computer system 2 and another computer system (not shown) over the network 160. For example, the processor 120 of the computer system 2 may forward a request or an instruction created based on a program code stored in the storage device such as the memory 110, data, and a file, to other computer systems over the network 160 under control of the communication interface 130. Inversely, a signal, an instruction, data, a file, etc., from another computer system may be received at the computer system 2 through the communication interface 130 of the computer system 2 over the network 160. A signal, an instruction, data, etc., received through the communication interface 130 may be forwarded to the processor 120 or the memory 110, and a file, etc., may be stored in a storage medium, for example, the permanent storage device, further includable in the computer system 2. For example, the communication interface 130 may be a hardware module such as a network interface card, a network interface chip, and a networking interface port of the computer system 2 or a software module such as a network device driver or a networking program.

The I/O interface 140 may be a device used for interfacing with an I/O device 150. According to some example embodiments, the I/O device 150 may include an input device and/or an output device. For example, the input device may include a device, such as a microphone, a keyboard, a mouse, a camera, etc., and the output device may include a device, such as a display, a speaker, etc. As another example, the I/O interface 140 may be a device for interfacing with an apparatus in which an input function and an output function are integrated into a single function, such as a touchscreen. The I/O device 150 may be configured as a single apparatus with the computer system 2.

Also, according to some example embodiments, the computer system 2 may include a number of components greater than or less than the number of components shown in FIG. 2. However, there is no need to clearly illustrate many components according to the related art. For example, the computer system 2 may be implemented to include at least a portion of I/O devices connected to the I/O interface 140, or may further include other components, for example, a transceiver, a Global Positioning System (GPS) module, a camera, various sensors, and/or a database. In more detail, for example, when the computer system 2 is implemented in a form of a mobile device such as a smartphone, the computer system 2 may be implemented to further include various components, such as a camera, an acceleration sensor or a gyro sensor, various types of physical buttons, a button using a touch panel, an I/O port, and/or a vibrator for vibration, which are generally included in the mobile device.

For example, the computer system 2 corresponding to the user terminal 100 may include a camera that captures surroundings to execute the AR view 10. The computer system 2 may display a video captured through the camera as the AR view 10. The computer system 2 may augment and display the 3D map 20 on the video of the AR view 10, and may output the content (35, 42, 44 and 46) based on interaction with the first object 30 included in the 3D map 20.

At least a portion of an operation or a computation performed for the computer system 2 to display the AR view 10 and the 3D map 20, and to output the content (35, 42, 44 and 46) may be performed not by the computer system 2 but by the server 200. The server 200 may be an electronic device that communicates with the computer system 2 (e.g., via the network 160) to provide data for controlling the user terminal 100 with respect to the computer system 2 and accordingly, allows the user terminal 100 to be controlled. The server 200 may include a database as a device that manages data and content to be provided to the computer system 2, and manages (registers, changes, deletes, stores, and maintains) the 2D map and the 3D map, or may communicate with a database or an external service that provides the same. Also, the server 200 may include a map server that provides a digital map (3D map and/or 2D map), or may be configured to communicate with the map server.

The server 200 may include at least one computer system. The computer system included in the server 200 may include the same components as (or components similar to) those of the computer system 2 described above and further description related thereto is omitted.

In some example embodiments, the user terminal 100 that is the computer system 2 may communicate with the server 200, and may be controlled based on data and/or information provided from the server 200. Here, the server 200 may receive the location of the user terminal 100 or the location designated from the user terminal, and may control the user terminal 100 to display the 3D map 20 within the AR view 10 based on the received location. Also, the server 200 may recognize that the interaction with the first object 30 is performed within the 3D map 20 in the user terminal 100 and accordingly, may transmit data for outputting the content (35, 42, 44 and 46) to the user terminal 100.

In the following detailed description, for clarity of description, some example embodiments are described based on the computer system 2 corresponding to the user terminal 100, and description related to communication with the server 200 and an operation on the server 200 may be simplified or omitted. Also, for clarity of description, actions (operations) performed by the component (e.g., processor) of the computer system 2 (or, server 200) may be described to be performed by the computer system 2 (or, server 200).

Description related to technical features described above with reference to FIG. 1 may also be applied to FIG. 2 as is and thus, redundant description is omitted.

FIG. 3 is a flowchart illustrating a method of controlling a user terminal to display a 3D map within an AR view, and to output content related to an object within the 3D map according to some example embodiments.

A control method of the user terminal 100 performed by the computer system 2 is described with reference to FIG. 3. The computer system 2 may be the user terminal 100 described with reference to FIG. 1, so the term of the user terminal 100 is used instead of the computer system 2 to describe the example.

Also, at least some of operations 310 to 620 to be described below with reference to FIGS. 3 to 6 may be configured to be performed by the server 200 rather than the user terminal 100. These operations are described below as being performed based on the user terminal 100 for clarity of explanation, and redundant description related to the server 200 may be omitted.

In operation 310, the user terminal 100 may display the AR view 10 that includes a video captured by a camera. The AR view 10 may be displayed as a full screen, or may be displayed on at least a partial area of the screen in the user terminal 100. The AR view 10 may be configured to augment and display content related to a corresponding object in association with the object included in the video.

In operation 320, the user terminal 100 may display the 3D map 20 of an area that includes a location of the user terminal 100 or a location designated by the user of the user terminal 100, through augmentation in the video within the AR view 10. The user terminal 100 may display the 3D map 20 in at least a partial area of the AR view 10. For example, the user terminal 100 may display the 3D map 20 on a portion corresponding to the bottom of the video of the AR view 10.

The 3D map 20 may represent an area that includes a current location of the user terminal 100. Here, the 3D map 20 may serve as a mini map for the video of the AR view 10.

Alternatively, the 3D map 20 may represent the area that includes the location designated by the user of the user terminal 100 (regardless of the current location of the user terminal 100). Here, the user may set a display area of the 3D map 20 within the AR view 10 through an area selection and an area search in a separate map application (e.g., map application that provides a 2D and/or 3D map service). Alternatively, the user may set the display area of the 3D map 20 in the AR view 10 through a search using voice (e.g., uttering an address and/or an administrative district). According to some example embodiments, the user may set the display area of the 3D map 20 by inputting an address, a city (or other regional identifier), GPS coordinates, etc.

The 3D map 20 may represent an administrative district (dong, gu, etc.) that includes the current location of the user terminal 100 or the location designated by the user, or a block separated by road. Alternatively, the range of the area represented by the 3D map 20 may be set by the user.

The scale of the 3D map 20 may be adjusted (e.g., zoomed in or zoomed out) in response to a manipulation on the user terminal 100, and a viewpoint thereof may change. When displaying the 3D map 20, the user terminal 100 may display the 3D map 20 using a changed viewpoint as a viewpoint of the camera for displaying the AR view 10 changes. Therefore, the user using the 3D map 20 may virtually experience the area represented by the 3D map 20 in a more intuitive manner.

As described above, the 3D map 20 may provide the user with an immersive experience in relation to the area represented by the 3D map 20, and, for example, may provide the user with an experience as if the user is actually in the area represented by the 3D map 20 (in a state in which the 3D map 20 is in a sufficiently enlarged manner within the AR view 10). For example, as the user terminal 100 moves with the user, displaying of the 3D map 20 may change accordingly. Therefore, the user may virtually experience or explore the area represented by the 3D map 20. Alternatively, the 3D map 20 may provide a function that allows the user to virtually experience or explore the area represented by the 3D map 20 in a manner similar to a street view or a street view service (e.g., a method of using a screen touch).

In operation 330, the user terminal 100 may output the content 35 that includes information related to the first object 30 based on the user's interaction with the first object 30 within the 3D map 20. For example, the first object 30 may represent at least one of land features present in a real-world environment corresponding to the 3D map 20. The first object 30 may be, for example, a Point of Interest (POI) included in the 3D map 20.

Alternatively, the first object 30 may include real estate within the area represented by the 3D map 20. The real estate may include a building, a multi-family building, an apartment, apartment complex (including a plurality of apartment buildings), other houses, and land, or a portion thereof.

The interaction with the first object 30 may be selecting the first object 30 from the 3D map 20 displayed within the AR view 10. The selecting may be selecting or touching the first object 30, or AR content or icon output in association with the first object 30. The AR content may include, for example, a name of the first object 30, such as a name of an apartment complex corresponding to the first object 30. Alternatively, the interaction with the first object 30 may include, for example, a voice command that calls information related to the first object 30, such as “Let me know of the first object 30.” Alternatively, the interaction with the first object 30 may include gazing the first object 30 on the AR view 10. This gazing may relate to maintaining the first object 30 by positioning the same in a certain area (e.g., central area) of the AR view 10.

If the interaction with the first object 30 as described above is recognized, the user terminal 100 may output the content 35 that includes information related to the first object 30.

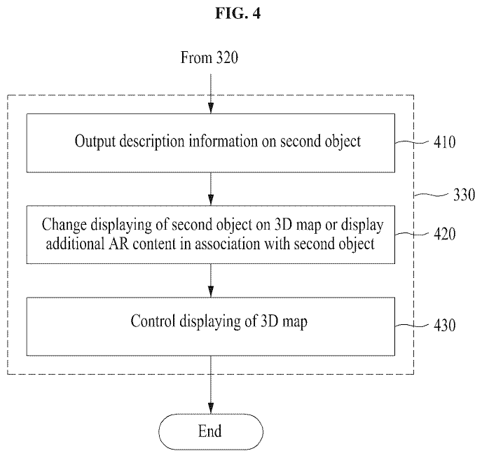

A more detailed method of displaying the 3D map 20 within the AR view 10 and providing the content 35 that includes information related to the first object 30 within the 3D map 20 is further described with reference to FIGS. 4 to 16 below.

Description related to technical features described above with reference to FIGS. 1 and 2 may also be applied to FIG. 4 as is and thus, redundant description is omitted.

FIG. 4 is a flowchart illustrating a method of controlling a user terminal when information that describes a second object on a 3D map is output from the content including information that describes a first object within the 3D map according to an example.

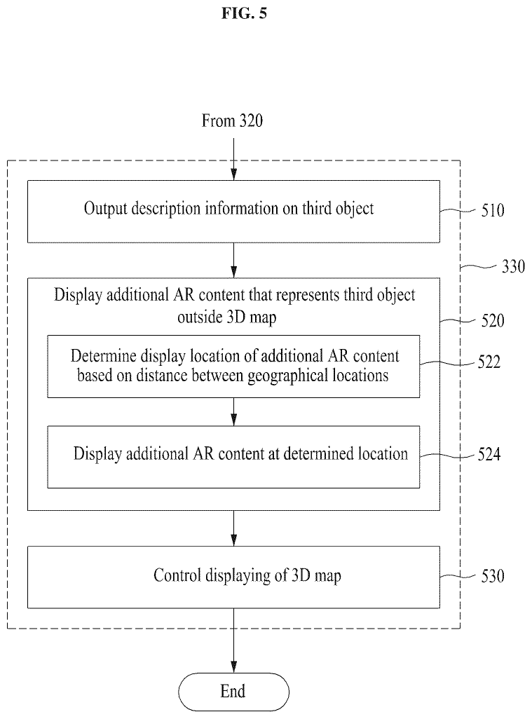

FIG. 5 is a flowchart illustrating a method of controlling a user terminal when information that describes a third object outside a 3D map is output from the content including information that describes a first object within the 3D map according to an example.

When the content 35 that includes information related to the first object 30 as described above is output, the content 35 may include description content including information that describes the first object 30. That is, if the aforementioned interaction is recognized, the user terminal 100 may output this description content. The description content may include text and/or audio content. When the description content includes the audio content, the audio content may be played back at the user terminal 100 as the interaction is recognized.

The description content may include information that describes the real estate corresponding to the first object 30. The information that describes the real estate may include, as basic information on the real estate, for example, surrounding environment information of the real estate, information on the date and year of completion, actual transaction price information, and information related to purchase, sale and/or lease of the real estate.

The information that describes the real estate may include at least one of information that describes the second object (object different from the first object 30) within the 3D map 20 in association with the real estate corresponding to the first object 30 and information that describes the third object outside the 3D map 20 in association with the real estate corresponding to the first object 30. The second object and the third object may be objects that are cited (or provided) to describe the surrounding environment of the real estate corresponding to the first object 30.

Referring again to FIG. 4, an example in which information that describes the real estate includes information that describes the second object within the 3D map 20 is described.

In operation 410, in terms of outputting the content 35 that includes information related to the first object 30, the user terminal 100 may output information that describes the second object.

In operation 420, when the information that describes the second object in the description content is output from the user terminal 100, the user terminal 100 may change displaying of the second object on the 3D map 20, or may further display additional AR content in association with the second object. For example, when text of information that describes the second object is displayed on the user terminal 100, or when audio content of information that describes the second object is played back at the user terminal 100, the user terminal 100 may change displaying of the second object on the 3D map 20, or may further display additional AR content in association with the second object.

Here, changing displaying of the second object may include at least one of highlight processing of the second object and/or motion effect processing of the second object (e.g., highlighting or applying a motion effect to the second object). According to some example embodiments, the highlight processing and/or motion effect processing may be performed similar to the augmenting discussed above. For example, pixels corresponding to the second object may be replaced with corresponding pixels illustrating a highlight and/or a motion effect. Therefore, in terms of being provided with information that describes the real estate corresponding to the first object 30, the user may visually recognize the corresponding second object when information that describes the second object representing another building, river, road, natural object, convenience facility, etc., around the corresponding real estate is output.

The additional AR content displayed in association with the second object may include at least one of an image and/or text that describes the second object; distance information from the real estate corresponding to the first object 30 to the second object; and/or route information from the real estate corresponding to the first object 30 to the second object. The image and/or text that describes the second object may include an image or an icon, and/or text that describes another building, river, road, natural object, convenience facility, etc., around the real estate corresponding to the first object 30. The distance information may include a distance from the real estate corresponding to the first object 30 to the second object, for example, another building, river, road, natural object, convenience facility, etc., and the route information may include a travel route from the real estate corresponding to the first object 30 to the second object.

In operation 430, in terms of changing displaying of the second object or further displaying the additional AR content in association with the second object in operation 420, the user terminal 100 may appropriately control displaying of the 3D map 20. For example, the user terminal 100 may control displaying of the 3D map 20 such that displaying of the second object may be changed or the additional AR content may be displayed in a predetermined (or alternatively, given) area of the AR view 10. For example, displaying of the 3D map 20 may be controlled such that change in displaying of the second object or displaying of the AR content may be performed at the center of the AR view 10.

As described above, in some example embodiments, information that describes the second object within the 3D map 20 as surrounding information on the real estate corresponding to the first object 30 may be output from the user terminal 100 in a way that is more effectively and intuitively recognized by the user.

Referring again to FIG. 5, an example in which information that describes the real estate includes information that describes the third object outside the 3D map 20 is described.

In operation 510, in terms of outputting the content 35 that includes information related to the first object 30, the user terminal 100 may output information that describes the third object.

In operation 520, when information that describes the third object of the description content is output from the user terminal 100, the user terminal 100 may further display additional AR content that represents the third object outside the 3D map 20. For example, as in operations 522 and 524, the user terminal 100 may determine a location at which the additional AR content is to be displayed within the AR view 10, based on a distance between a geographical location of the real estate corresponding to the first object 30 and a geographical location of the third object, and may display the additional AR content at the determined location.

The additional AR content displayed in association with the third object may include at least one of an image and/or text that describes the third object; distance information from the real estate corresponding to the first object 30 to the third object; and route information from the real estate corresponding to the first object 30 to the third object. The image and/or text that describes the third object may include an image or an icon, and/or text that describes another building, river, road, natural object, convenience facility, etc., around the real estate corresponding to the first object 30. The distance information may include a distance from the real estate corresponding to the first object 30 to the third object, for example, another building, river, road, natural object, convenience facility, etc., and the route information may include a travel route from the real estate corresponding to the first object 30 to the third object.

In operation 530, in terms of further displaying the additional AR content in operation 520, the user terminal 100 may appropriately control displaying of the 3D map 20. For example, the scale of the 3D map 20 may be adjusted based on a distance between a geographical location of the real estate corresponding to the first object 30 and a geographical location of the third object. Here, the scale of the 3D map 20 may be automatically adjusted such that the additional AR content and the 3D map 20 may be displayed on a single screen of the user terminal 100. Therefore, in some example embodiments, the scale of the 3D map 20 may be appropriately adjusted such that the 3D map 20 and the additional AR content may be displayed on a single screen.

In this way, in some example embodiments, information that describes the third object present outside the 3D map 20 as surrounding information on the real estate corresponding to the first object 30 may be provided from the user terminal 100 in a way that is more effectively and intuitively recognized by the user.

Hereinafter, the content 35 that includes information related to the first object 30 and a method of controlling displaying of the AR view 10 when information that describes the second object is output and information that describes the third object is output, respectively, in terms of providing the content 35 are further described with reference to FIGS. 7 to 15.

FIG. 7 illustrates content including information that describes a first object within a 3D map according to an example.

The illustrated content 35 may be an example of description content including the aforementioned information that describes the first object 30. The content 35 may be output from the user terminal 100 in a text form, alternatively or additionally the content 35 may be played back in the user terminal 100 in the form of audio content. This audio content may be considered to correspond to “audio guide.”

As in the illustrated example, the content 35 may be constructed with the content “Apartment complex A has office building N across the street, and if you go a little further, Tancheon flows, so it is a good location for a walk. On the opposite side, Taebongsan and Jinjaesan are surrounding, so the top floor penthouse offers the unobstructed mountain scenery. It is also close to the café alley, making it a great place to enjoy brunch on the weekend.”

Here, Apartment complex A 710 may represent the first object 30 (e.g., real estate corresponding to the first object 30). Office building N 720, Tancheon 730, and café alley 750 may each represent the second object corresponding to the surrounding environment of the first object 30. Taebongsan and Jinjaesan 740 may each represent the third object corresponding to the surrounding environment of the first object 30.

In this way, the content 35 may include information on a direction in which the user needs (or otherwise, is directed, guided, etc.) to move within the 3D map 20, available roads, a destination corresponding to another object, a portion of the 3D map 20 to be examined, etc.

The user may explore the area represented by the 3D map 20 by controlling displaying of the 3D map 20 (e.g., by rotating the user terminal 100), while listening to the content 35 output in the form of audio content, for example.

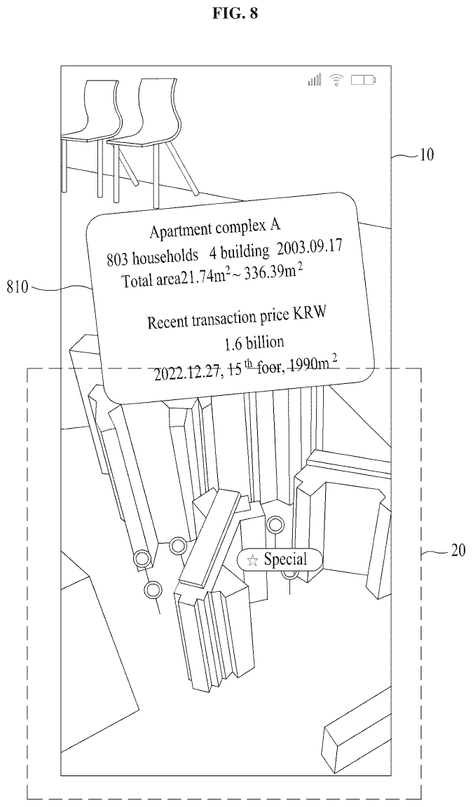

FIGS. 8 to 14 illustrate a method of displaying a 3D map within an AR view and outputting content related to an object within the 3D map according to an example.

As illustrated in FIG. 8, the 3D map 20 may include an icon representing the first object 30 or AR content 810 (e.g., the AR content 810 may represent the first object 30). As the AR content 810 is selected, the content 35 may be output from the user terminal 100.

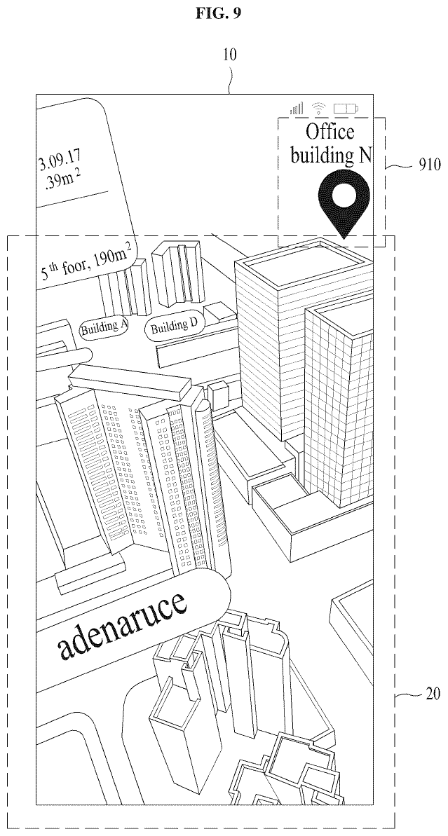

When the content, such as “has office building N across the street” in the content 35, is output from the user terminal 100, additional AR content 910 may be displayed on the 3D map 20 as illustrated in FIG. 9. Here, a building corresponding to office building N may correspond to the aforementioned second object. Also, although not illustrated, when the content, such as “has office building N across the street,” is output from the user terminal 100, displaying of the building corresponding to office building N corresponding to the second object may also be additionally or alternatively changed.

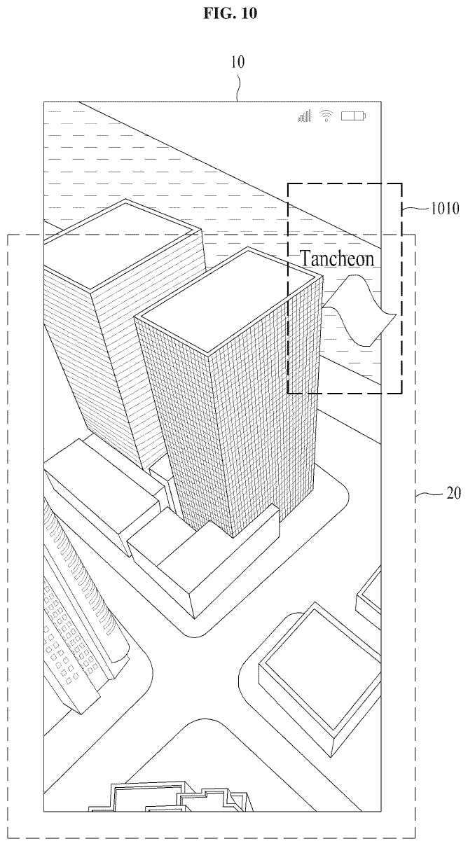

Also, when the content, such as, for example, “if you go a little further, Tancheon flows, so it is a good location for a walk” in the content 35 is output from the user terminal 100, additional AR content 1010 may be displayed on the 3D map 20 as illustrated in FIG. 10. Here, a stream corresponding to Tancheon may correspond to the aforementioned second object. Also, although not illustrated, when the content, such as “if you go a little further, Tancheon flows, so it is a good location for a walk”, is output from the user terminal 100, displaying of the stream corresponding to Tancheon corresponding to the second object may also be additionally or alternatively changed. For example, a motion effect, such as flowing river, may be applied to the second object.

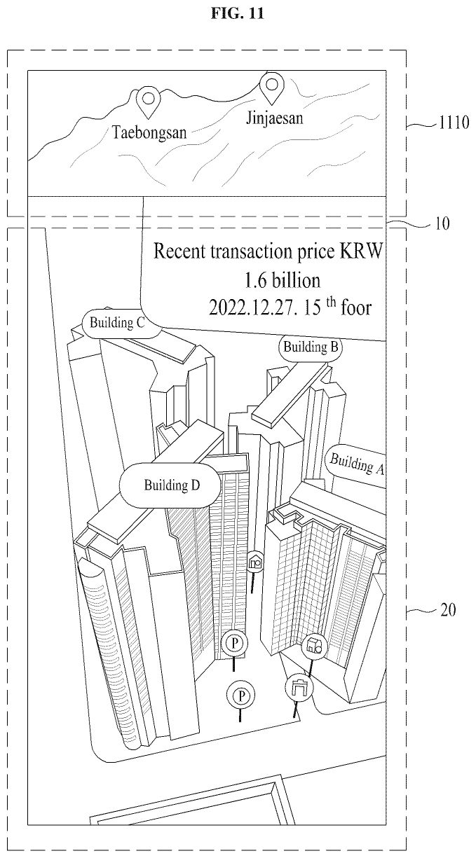

Also, when the content, such as, for example, “On the opposite side, Taebongsan and Jinjaesan are surrounding, so the top floor penthouse offers the unobstructed mountain scenery.” in the content 35 is output from the user terminal 100, additional AR content 1110 may be displayed on the 3D map 20 as illustrated in FIG. 11. Here, the mountains corresponding to Taebongsan and Jinjaesan may each correspond to the aforementioned third object. The third object may not be included in the scope of the 3D map 20, and may be displayed outside the 3D map 20.

Also, when the content 35, such as, for example, “It is also close to the café alley, making it a great place to enjoy brunch on the weekend.”, is output from the user terminal 100, additional AR content 1410 may be displayed on the 3D map 20 as illustrated in FIG. 14. Here, a street or road corresponding to the café alley may correspond to the aforementioned second object. Also, although not illustrated, when the content 35 “It is also close to the café alley, making it a great place to enjoy brunch on the weekend.” is output from the user terminal 100, displaying of the object corresponding to the street or the road corresponding to the second object may be additionally or alternatively changed.

Also, as illustrated in FIG. 14, a route 1420 and/or an arrival time 1425 corresponding to another building, river, road, natural object, convenience facility, etc., corresponding to the second object may be displayed as the additional AR content in the AR view 10. For example, to determine accessibility to a public transportation (e.g., subway station, bus stop, etc.) and/or accessibility to a school, which may be important factors to determine transaction of real estate, a route and/or arrival time to a public transportation station or a route and/or arrival time to a school may be displayed as the additional AR content in the AR view 10. The additional AR content may be appropriately output from the user terminal 100 depending on the contents of the content 35 and an output timing of the content 35.

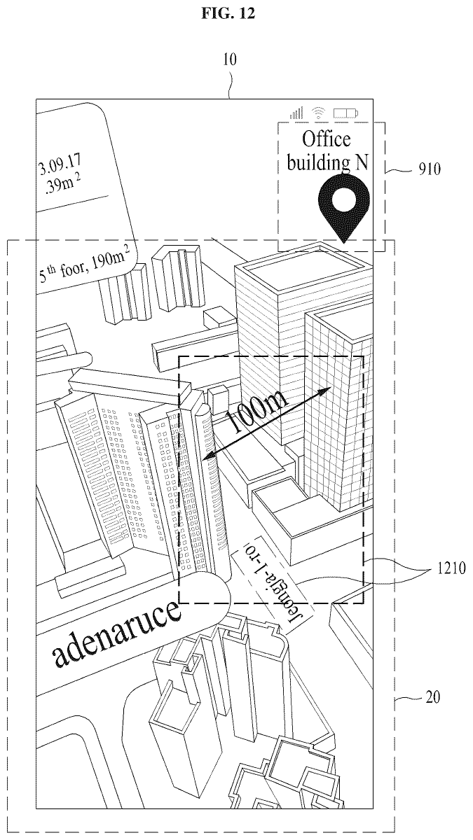

Also, as illustrated in FIG. 12, a straight-line distance between the first object 30 and the second object (e.g., distance between buildings, distance between apartment buildings, etc.) or information on surrounding roads may be displayed as additional AR content 1210 in the AR view 10. This additional AR content may be appropriately output from the user terminal 100 depending on the contents of the content 35 and output timing of the content 35.

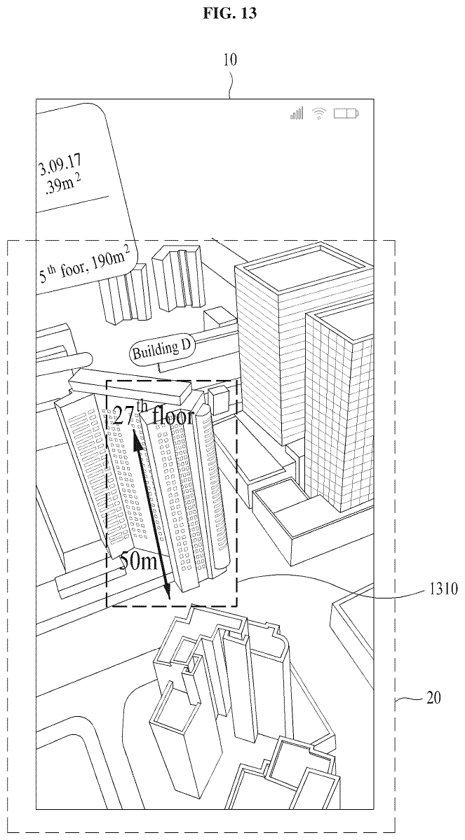

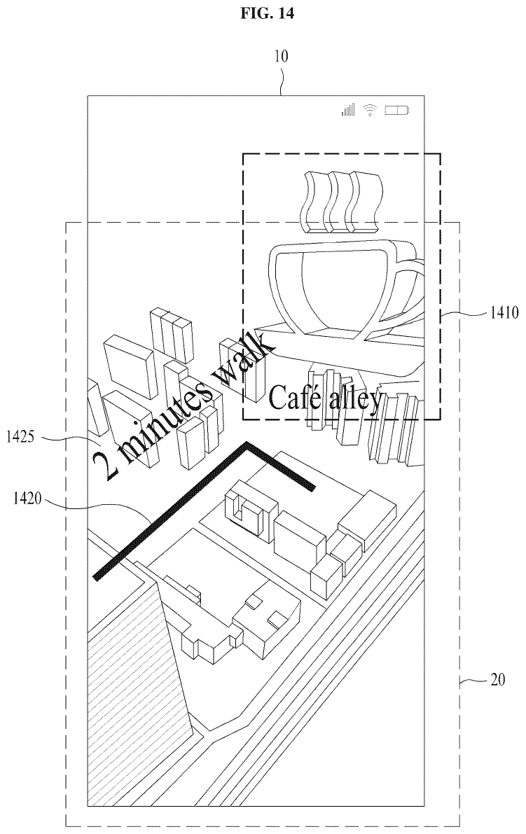

Also, as illustrated in FIG. 13, information on the height or terrain or floor information of the first object 30 (e.g., height and/or floor information of building) may be displayed as additional AR content 1310 in the AR view 10. This additional AR content may be appropriately output from the user terminal 100 depending on the contents of the content 35 and output timing of the content 35. Similarly, information on the height or terrain or floor information of the second object (e.g., height and/or floor information of surrounding building) may also be displayed as the additional AR content in the AR view 10.

As described with reference to FIGS. 9 to 14, output of the additional AR content in the AR view 10 may be performed in synchronization with output or playback of the content 35.

In some example embodiments, in terms of outputting the content 35, the user terminal 100 may output the content including orientation information centered on the first object 30 and information that describes the first object 30 and other objects (aforementioned second object and third object) around the first object 30. According to some example embodiments, the content 35 includes information that describes the first object 30 and other objects (aforementioned second object and third object) around the first object 30 by including the orientation information centered on the first object.

For example, the content 35 may include the orientation information on east, west, south, and north or up, down, left, and right of the first object 30 and other objects (aforementioned second object and third object) around the first object 30. This orientation information may be based on a current location of the user terminal 100. According to some example embodiments, the current location of the user terminal 100 may be determined by the user terminal 100 using a satellite positioning (e.g., Global Positioning System (GPS)) receiver, by performing triangulation based on signals received from base stations of the network 160, or any other process that would be understood by a person of ordinary skill in the art. According to some example embodiments, the current location of the user terminal 100 may be determined by the server 200 based on information received from the user terminal 100, a signal strength (and/or signal directionality) of wireless signals transmitted by the user terminal 100 to the server 200, or any other process that would be understood by a person of ordinary skill in the art.

For example, in the content 35 described above with FIG. 7, ““has office building N across the street” may be constructed as “If you look to the right, you will see office building N,” “if you go a little further, Tancheon flows, so it is a good location for a walk.” may be constructed as “Tancheon flows further to the right, so it is a good location for a walk,” and “On the opposite side, Taebongsan and Jinjaesan are surrounding, so the top floor penthouse offers the unobstructed mountain scenery.” may be constructed as “On the left, Taebonsan and Jinjaesan surround the building, so the top floor penthouse offers the unobstructed mountain scenery.”

At least one of the additional AR content described above with reference to FIGS. 9 to 14 may be output from the user terminal 100 when a command that calls information corresponding to the additional AR content is received by the user terminal 100, regardless of the output of the content 35.

For example, a plurality of objects may be included in the 3D map 20, and output of content may be associated with the objects. For example, a command that outputs content or the content itself may be mapped or tagged on the object. The content may include at least one of text, audio content, and/or AR content.

For example, as in operation 340 of FIG. 3, as (e.g., in response to) the command that calls information on at least one of the objects is received, the user terminal 100 may display, on the 3D map 20, content related to an object indicated by the command. The displayed content may be at least one additional AR content described above with reference to FIGS. 9 to 14.

For example, when a command that requests route information from a specific object to another object on the 3D map 20 is received, or when a command that requests information on facility, such as a school, is received, the additional AR content as described with reference to FIGS. 9 to 14 may be displayed in the AR view 10. The command for displaying the additional AR content may be received by the user terminal 100 in a state in which the first object 30 is selected. The command may include a voice command (query).

In this way, some example embodiments may be implemented to output the additional AR content in the AR view 10 while predetermined (or alternatively, given) description content is being output, or to output the additional AR content in the AR view 10, if necessary (or otherwise, desirable), according to a command from the user.

Description related to the technical features described above with reference to FIGS. 1 to 3 may be applied to FIGS. 4, 5, and FIGS. 7 to 14 as is and thus, redundant description is omitted.

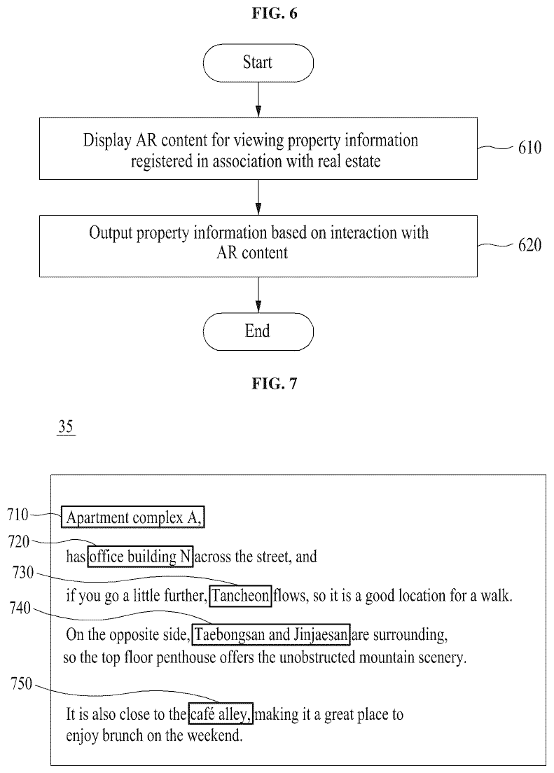

FIG. 6 is a flowchart illustrating a method of outputting property information registered in association with real estate within an AR view when an object within a 3D map is real estate according to an example.

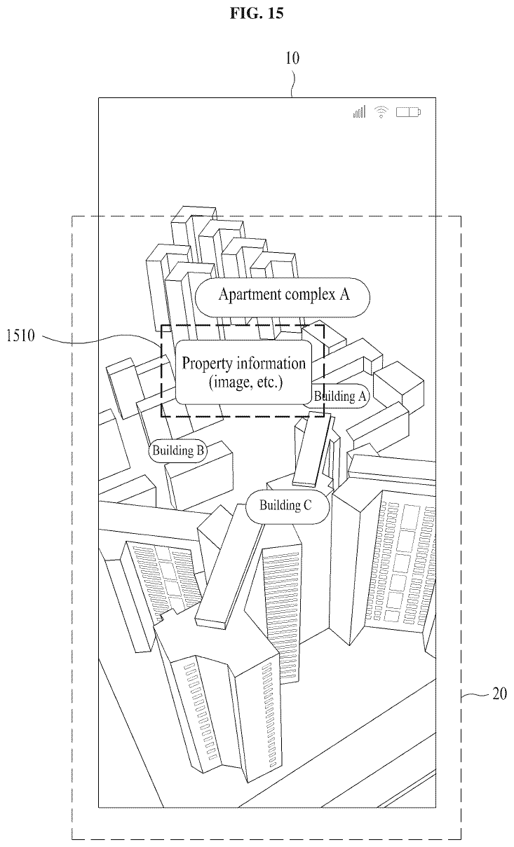

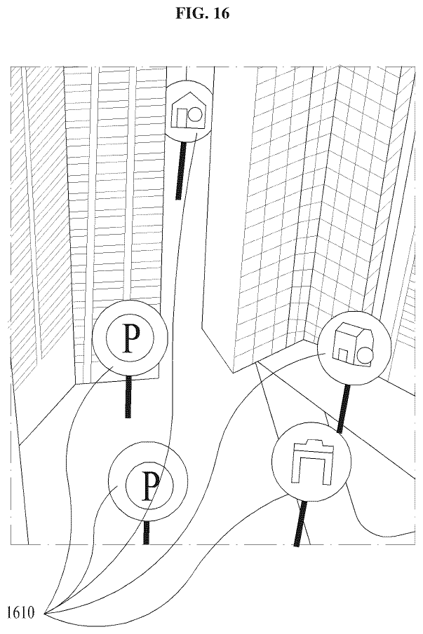

In this regard, FIG. 15 illustrates a method of outputting property information registered in association with real estate within an AR view according to an example.

As described above, the first object 30 within the 3D map 20 may include real estate within an area.

In operation 610, the user terminal 100 may display AR content (e.g., icon indicating AR content 1510 or name of the first object 30) for viewing property information for properties for sale registered to the real estate corresponding to the first object 30 in association with the first object 30.

In operation 620, the user terminal 100 may output the property information based on the user's interaction with the AR content 1510.

The property information may include audio content and/or visual content.

The property information may be viewed by touching an icon (e.g., AR content 1510) indicating a property displayed on the real estate corresponding to the first object 30. The property information may include description regarding an area and an internal structure of the property, description of price, and description regarding features of the property. When the property information is output as audio content, background music may also be provided. The contents of the property information to be provided may be differently configured depending on characteristics of the property.

As illustrated, the AR content 1510 may include an interior photo as an image related to the property, and the image may be viewed by selecting a thumbnail of the image included in the AR content 1510 by the user terminal 100 or by enlarging and displaying the AR content 1510.

Therefore, the user who desires to acquire property information of the real estate may acquire the property information in an intuitive manner without a need to visit a real estate agency or the location of the real estate in the area.

Description related to the technical features described above with reference to FIGS. 1 to 5 and FIGS. 7 to 14 may be applied to FIGS. 6 and 15 as is and thus, redundant description is omitted.

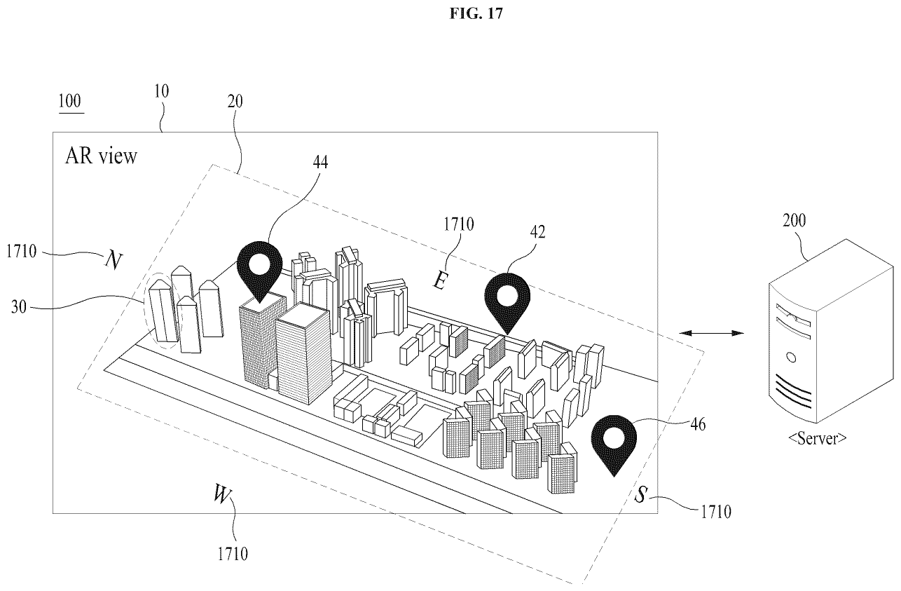

FIG. 16 illustrates objects and Points of Interest (POIs) included in a 3D map displayed within an AR view according to an example.

FIG. 16 illustrates a screen of the user terminal 100 on which the 3D map 20 is enlarged, which is described above.

The 3D map 20 may include a plurality of objects and, as illustrated, each of POIs 1610 and buildings may correspond to an object. As illustrate, the POIs 1610 may represent a facility of the building, such as entrance of the building and a parking lot of the building.

In some example embodiments, in response to a selection on each of the POIs 1610, content that includes information related to the corresponding POI 1610 may be output from the user terminal 100. Also, in response to a selection on a specific building on the 3D map 20 rather than one of the POIs 1610 displayed using an icon, content that includes information related to an object corresponding to the selected building may be output from the user terminal 100.

Description related to the technical features described above with reference to FIGS. 1 to 15 may be applied to FIG. 16 as is and thus, redundant description is omitted.

In the aforementioned examples, the content 35 that includes information related to the real estate is output together with the 3D map 20 through the AR view 10 and the additional AR content is further output in synchronization with output of the content 35, so specialized information on the corresponding real estate or an area represented by the 3D map 20 may be provided to the user in an effective manner. For example, the user may virtually visit a region of interest through the 3D map 20, and may easily acquire real estate information of the corresponding area.

FIG. 17 illustrates a method of displaying a 3D map within an AR view such that the orientation of the AR view matches the orientation of the 3D map based on orientation information of the AR view according to some example embodiments.

As described above with reference to FIG. 1, the user terminal 100 such as a smart phone may capture a surrounding area using a camera, and may display, on the screen, the AR view 10 that includes a video captured by the camera. The user terminal 100 may display the 3D map 20 of the area that includes the location of the user terminal 100 or the location designated by the user of the user terminal 100, through augmentation in at least a partial area of the AR view 10, that is, the video within the AR view 10.

Here, the user terminal 100 may display the 3D map according to orientation information of the AR view 10 acquired from the server 200 or the user terminal 100, through augmentation in the video within the AR view 10. Therefore, the orientation of the video within the AR view 10 and the orientation of the 3D map 20 may match. The orientation information of the AR view 10 may include east, west, south, north (or up, down, left, right) orientation information of the AR view 10. For example, the north in the video of the AR view 10 may be the same as (or similar to) the north in the 3D map 20. According to some example embodiments, the orientation of the AR view 10 corresponding to the camera view of the user terminal 100 may be determined based on the current position of the user terminal 100 and the a current direction corresponding to a viewpoint of the camera. According to some example embodiments, the current direction corresponding to the camera viewpoint may be determined by the user terminal 100 using one or more sensors of the user terminal 100 (e.g., a GPS receiver, an accelerometer, a gyroscope, a compass, etc.), or any other process that would be understood by a person having ordinary skill in the art. According to some example embodiments, the orientation information of the AR view 10 may correspond to an absolute geographical orientation (e.g., cardinal directions of east, west, north and south) or to a relative orientation corresponding to the camera viewpoint (e.g., left, right, up and down). According to some example embodiments, the 3D map may be stored in association with orientation data that may be used by the user terminal 100 to align the 3D map with the orientation of the AR view 10 when augmenting the video in the AR view 10 based on the orientation information and the orientation data associated with the 3D map.

In this way, in some example embodiments, since the orientation in the 3D map 20 displayed in the AR view 10 and the orientation in an actual environment (real world) match, the user that uses the 3D map 20 may clearly recognize directions of the objects within the 3D map 20 based on a current location.

In some example embodiments, as illustrated, orientation information 1710 may be further displayed around the 3D map 20 within the AR view 10. Therefore, the user that uses the 3D map 20 may more intuitively recognize the directions of the objects within the 3D map 20.

Description related to the technical features described above with reference to FIGS. 1 to 16 may be applied to FIG. 17 as is and thus, redundant description is omitted.

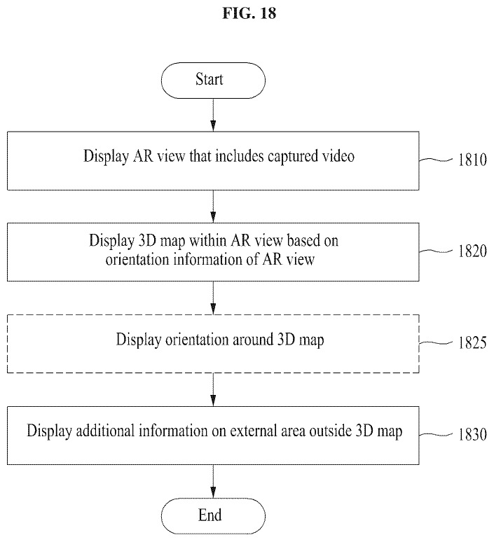

FIG. 18 is a flowchart illustrating a method of controlling a user terminal to display a 3D map within an AR view such that the orientation of the AR view matches the orientation of the 3D map, and to further display additional information on an external area outside the 3D map according to some example embodiments.

In operation 1810, the user terminal 100 may display the AR view 10 that includes a video captured by the camera. The AR view 10 may be displayed as a full screen or may be displayed on at least a partial area of the screen on the user terminal 100. The AR view 10 may be configured to augment and display content related to a corresponding object in association with the object included in the video.

In operation 1820, the user terminal 100 may display the 3D map 20 of an area that includes a location of the user terminal 100 or a location designated by the user of the user terminal 100 based on orientation information of the AR view 10 acquired from the server 200 or the user terminal 100, through augmentation in the video within the AR view 10.

The contents described above with reference to FIGS. 1 to 16 may also be similarly applied to the 3D map 20, so redundant description is omitted.

The orientation information may be received from the server 200, or may be acquired based on a compass or a sensor electronically implemented, included in the user terminal 100. The orientation information may include east, west, south, north (or up, down, left, right) direction information of the AR view 10.

In some example embodiments, the orientation of the video within the AR view 10 and the orientation of the 3D map 20 may match.

In operation 1825, the user terminal 100 may further display the orientation information 1710 around the 3D map 20 within the AR view 10. The orientation information 1710 may include the orientation that indicates east, west, south, north (or up, down, left, right) direction of the AR view 10. Through the orientation information 1710, the user that uses the 3D map 20 may more intuitively recognize directions of the objects within the 3D map 20.

When displaying the 3D map 20, a viewpoint of the camera of the user terminal 100 changes. Therefore, if a viewpoint and orientation of the video of the AR view 10 change, the user terminal 100 may change and display the 3D map 20 to match the changed viewpoint and orientation. In this way, displaying of the 3D map 20 may be controlled in conjunction with a movement of the user terminal 100 (e.g., movement of camera), and accordingly, may provide an immersive experience to the user that uses the 3D map 20.

In operation 1830, the user terminal 100 may display additional information on an area outside the 3D map 20, that is, an external area (e.g., an external geographical area) of an area (e.g., a first geographical area) represented by the 3D map 20 through augmentation in the video within the AR view 10. That is, the user terminal 100 may display the 3D map 20 in the certain range of the area that includes the current location of the user terminal 100 and the location designated by the user, and may also further display additional information on the wider range of the external area than the area in the AR view 10.

This additional information may include additional content that includes information on a 2D map and/or external area.

In some example embodiments, by augmenting the 3D map 20 using the AR view 10, instead of the existing method, for example, a web or app interface method, a more immersive experience may be provided to the user that uses the 3D map 20. That is, the user may experience as if the user directly enters and views the space represented by the 3D map 20.

The proposed 3D map 20 may represent only a limited area compared to a 3D map provided through the web or app interface method. For example, the 3D map 20 augmented within the AR view 10 may be provided to represent an area less than or equal to a preset (or alternatively, given) data size or less than or equal to preset (or alternatively, given) regional range. Additional information on the external area of the area represented by the 3D map 20 may be meshed up to be provided from around the 3D map 20 as light format data with less load for rendering relative to the 3D map 20. According to some example embodiments, references herein to meshing up or mashing up information may also broadly refer to combining the information.

Therefore, in some example embodiments, depending on a scenario (acquisition of real estate information, travel information, etc.) required (or otherwise, experienced or indicated) by the user, an area corresponding to the user's Region of Interest (ROI) may be rendered through the 3D map 20, and peripheral information may be provided around the 3D map 20 in such a manner that information, such as a 2D map or a POI extracted from the 2D map is meshed up. In this manner, the user terminal 100 in some example embodiments may reduce a load used for rendering the 3D map 20, and may output information on ROI and surrounding areas thereof in an efficient manner.

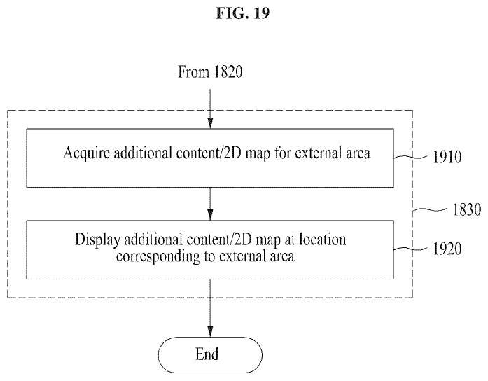

A more detailed method of further displaying additional information on the external area in the AR view 10 is further described with reference to FIGS. 19 to 24 below.

Description related to the technical features described above with reference to FIGS. 1 to 17 may be applied to FIG. 18 as is and thus, redundant description is omitted.

FIG. 19 is a flowchart illustrating a method of displaying additional content or a two-dimensional (2D) map as additional information on an external area outside a 3D map according to an example.

In operation 1910, the user terminal 100 may acquire additional content and/or a 2D map as additional information on an external area of an area represented by the 3D map 20.

In operation 1920, the user terminal 100 may display the additional content and/or 2D map acquired in operation 1910 at a location of the AR view 10 corresponding to the external area. The location of the AR view 10 corresponding to the external area may represent a location of the external area relative to the 3D map 20 (e.g., area represented by the 3D map 20). According to some example embodiments, operations 1910 and 1920 may be performed as part of operation 1830 (discussed above) after performance of operation 1820 and/or operation 1825.

Describing an example of operations 1910 and 1920 in more detail, the user terminal 100 may acquire the additional content on the external area from a map service that provides the 2D map including the external area as additional information on the external area of the area represented by the 3D map 20. The 2D map may be provided through a separate map application (e.g., map application that provides a 2D and/or 3D map service) as a commercial map.

The user terminal 100 may display the acquired additional content in an area corresponding to the external area outside the 3D map 20. This additional content is not the 2D map itself, but may include information on the external area extracted from the 2D map or acquired from the service that provides the 2D map.

For example, the additional content may include, as real-time information on the external area, at least one of traffic information of the external area, air quality information of the external area, real-time video information of the external area, etc. The real-time video information may include a video captured from a Closed-Circuit Television (CCTV) camera or a surveillance camera installed in the external area.

This real-time information may be displayed within the AR view 10 in the form of a numerical value, a graph, and/or a diagram. Alternatively, this real-time information may be displayed within the AR view 10 by overlapping the 2D map that represents the external area. That is, the real-time information provided in the form of traffic information, air quality information, and/or real-time video information in the 2D map may be displayed with the AR view 10 by being overlapped on the 2D map. This real-time information may be acquired from a map service or a service that provides separate real-time information.

Alternatively or additionally, the additional content may include at least one POI included in the external area. This POI may be displayed at a location outside the 3D map 20 corresponding to a location of the POI in the 2D map of the external area, and the user terminal 100 may determine a location on the AR view 10 at which the POI is to be displayed in consideration of a location of the external area relative to the 3D map 20 (e.g., area represented by the 3D map 20), and may display the POI as additional content at the determined location.

The POI displayed in the AR view 10 may be selected from among POIs included in the 2D map of the external area. That is, the user terminal 100 may determine POIs corresponding to public transportation stations (subway stations, bus stops, etc.), major facilities such as schools, public facilities, etc., as POIs to be displayed in the AR view 10. Alternatively, POIs of a category selected according to a selection from the user of the user terminal 100 may be determined as POIs to be displayed in the AR view 10. Such categories may include, for example, a public facility category, a natural object category (mountain, river, etc.), a store category (restaurant, shopping mall, etc.), a housing category (apartment, efficiency apartment, etc.), etc.

Then, an example of displaying a 2D map in an AR view as the additional information is further described as a more detailed example of operations 1910 and 1920.

The user terminal 100 may acquire the 2D map that includes the external area as additional information on the external area of the area represented by the 3D map 20. The 2D map may be provided through a separate map application (e.g., map application that provides 2D and/or 3D map service) as a commercial map, and the 2D map may be acquired from this map application or the map service.

The user terminal 100 may display the 2D map that includes the external area through augmentation in the video within the AR view 10 as the additional information on the external area. The 2D map may be displayed in the area corresponding to the external area outside the 3D map.

Therefore, the 3D map 20 may be displayed for the user's region of interest in the AR view 10, and the 2D map may be displayed for the external area outside the region of interest. The region of interest may indicate an area that is displayed as the 3D map 20 and requires (or alternatively, provides for) direct visual inspection by the user, and the external area may indicate a certain range of area around the area.

The 2D map may include, for example, at least one of a vector map of the external area, a satellite map of the external area, a cadastral edit map of the external area, a topographic map of the external area, and/or a schematic map of the external area. This 2D map may be layered and displayed in the AR view 10.

The 2D map may be selectively displayed through augmentation in the video within the AR view 10 according to a selection from the user terminal 100. That is, the user terminal 100 may receive a selection from the user regarding at least one of the vector map, the satellite map, the cadastral edit map, the topographic map, and/or the schematic map, or a layer to be displayed in the AR view 10 among the layers thereof, and may display the 2D map corresponding to the selected layer in the AR view 10.

The user terminal 100 may display the 2D map to overlap the 3D map 20 (or the 3D map 20 may overlap the 2D map such that the 3D map 20 at least partially covers the 2D map). The 3D map 20 may be displayed on the 2D map. Therefore, the 2D map may not be identified in an area in which the 3D map 20 of the AR view 10 is displayed.

However, depending on some example embodiments, the 2D map may be overlappingly displayed even in an area in which the 3D map 20 is displayed. Here, the 2D map may be semi-transparently displayed in the AR view 10.

The 2D map may be configured to be semi-transparently displayed in the AR view 10, and to minimize (or reduce) interference with the video of the AR view 10.

Also, the aforementioned additional content may be further displayed on the 2D map.

As described above, in some example embodiments, the 2D map and/or additional content may be displayed in the AR view 10 as additional information on the external area.

Description related to the technical features described above with reference to FIGS. 1 to 18 may be applied to FIG. 19 as is and thus, redundant description is omitted.

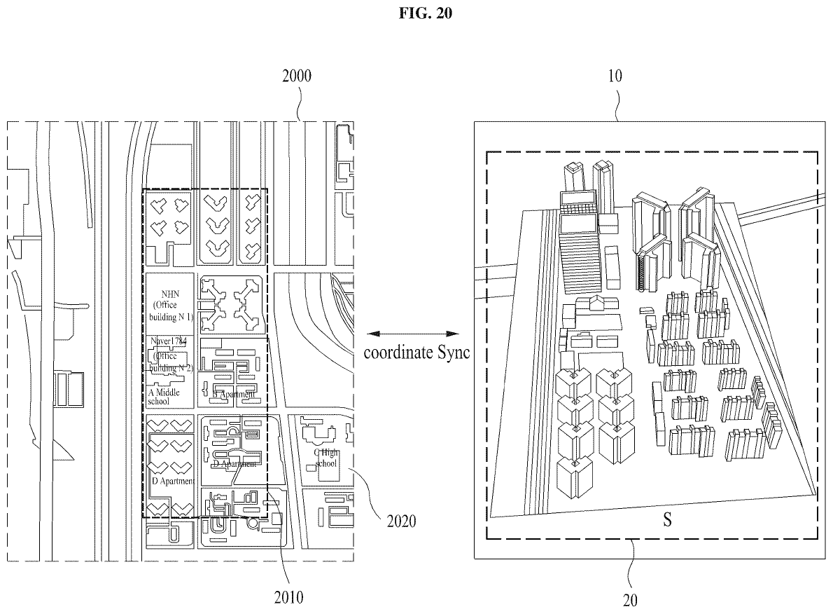

Hereinafter, a method of displaying the 2D map and/or additional content in the AR view 10 as additional information on the external area of the area represented by the 3D map 20 is described in more detail with reference to FIG. 20 and FIGS. 21 to 24.

FIG. 20 illustrates a method of matching coordinates of a 3D map and coordinates of a 2D map representing an area of the 3D map and an external area thereof according to an example.

As illustrated, the external area may be identified by matching (or synchronizing, mapping, etc.) coordinates on a 2D map 2000 and coordinates on the 3D map 20. That is, as coordinates of a certain area that are coordinates on the 3D map 20 match coordinates on the 2D map 2000 that is an area including a corresponding area 2010, an external area of the area, that is, an external area 2020 outside the 3D map 20 may be identified. Coordinate matching and external area identification processing may be performed by the server 200. According to some example embodiments, the coordinates of each of the 2D map 2000 and the 3D map 20 may be GPS coordinates, but some example embodiments are not limited thereto and the coordinates of each of the 2D map 2000 and the 3D map 20 may refer to any coordinate system(s) consistent or convertible between that of the 2D map 2000 and that of the 3D map 20.

The user terminal 100 may acquire, as the aforementioned additional information on the external area 2020, at least one of a 2D map of the external area 2020 identified according to coordinate matching, real-time information on the identified external area 2020, and information extracted from the 2D map of the identified external area 2020.

As the external area 2020 is identified, a location on the AR view 10 at which the additional information on the external area 2020 is to be displayed may be determined.

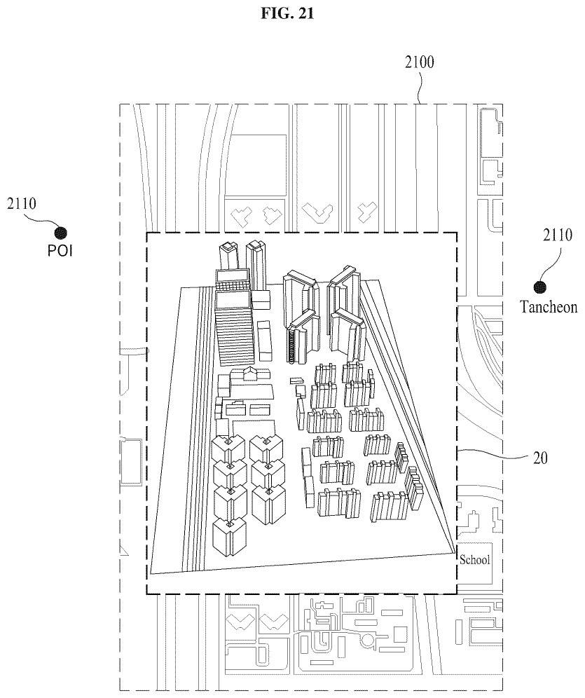

Then, a detailed example of displaying the additional information on the external area 2020 is further described with reference to FIGS. 21 to 24.

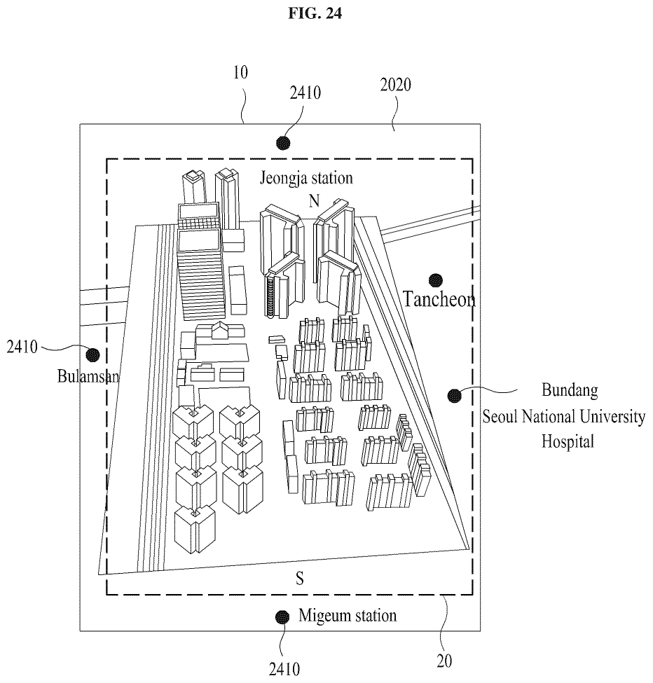

FIGS. 21 to 23 illustrate a method of displaying a 2D map in an external area outside a 3D map within an AR view according to an example. FIG. 24 illustrates a method of displaying POI information as additional content in an external area outside a 3D map within an AR view according to an example.

As illustrated in FIGS. 21 to 23, the 2D map of the external area 2020 identified around the 3D map 20 may be displayed.

In FIG. 21, a general 2D map (e.g., vector map) 2100 is displayed around the 3D map 20 within the AR view 10. As illustrated, additional information on the external area 2020 may be provided through the 2D map 2100 of the external area 2020 outside the 3D map 20. As illustrated, other additional information 2110 may be further displayed outside the 2D map 2100. The other additional information 2110 may include POI(s). The aforementioned description related to a method of displaying additional content may be similarly applied to a method of displaying the other additional information 2110 and thus, redundant description is omitted.

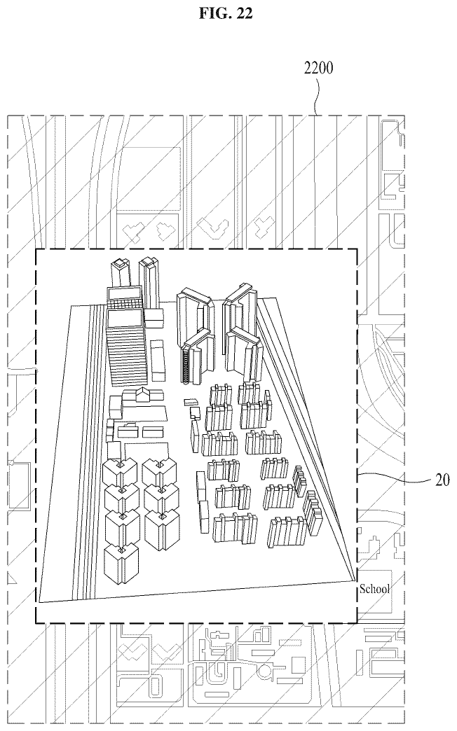

In FIG. 22, within the AR view 10, a 2D map 2200 that is a satellite map (may also be referred to herein as the satellite map 2200) is displayed around the 3D map 20. As illustrated, additional information on the external area 2020 may be provided through the satellite map 2200 of the external area 2020 outside the 3D map 20.

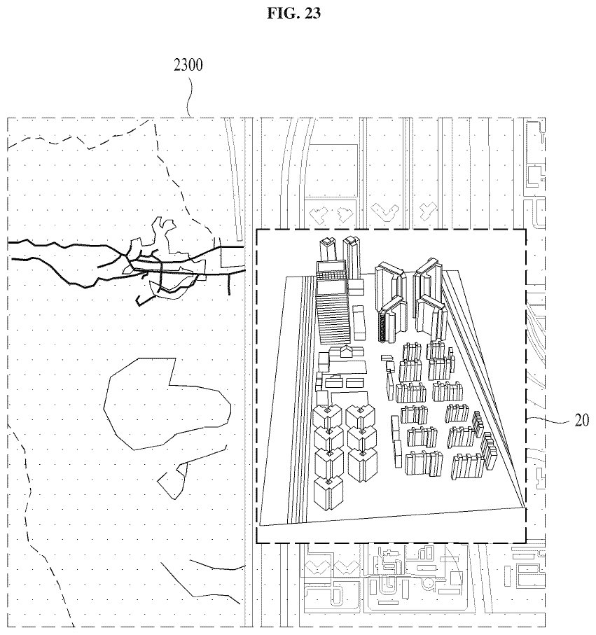

In FIG. 23, within the AR view 10, a 2D map 2300 that is a topographic map (cadastral edit map) is displayed around the 3D map 20. As illustrated, additional information on the external area 2020 may be provided through the topographic map 2300 of the external area 2020 outside the 3D map 20. For example, the schematic terrain or land information of the external area 2020 may be verified through the topographic map 2300. As illustrated, when displaying the topographic map 2300, the external area 2020 may be set to be wider than when displaying other 2D maps.

In FIG. 24, within the AR view 10, a plurality of POIs 2410 are displayed around the 3D map 20. The POIs 2410 provide additional information on the external area 2020 and, for example, may be extracted from the aforementioned 2D map 2100, 2200, 2300. The aforementioned description related to the method of displaying additional content may be similarly applied to a method of displaying the POIs 2410 and thus, redundant description is omitted.

The 2D maps 2100, 2200, and 2300 described with reference to FIGS. 21 to 23 may be acquired from a map service that provides such a 2D map.

Also, as described above, additional information on the external area 2020 may be configured to include real-time information. This real-time information may be acquired from a map service or a service that provides separate real-time information.

As described with reference to FIGS. 21 to 24, in some example embodiments, the user terminal 100 may mash up information from at least one of a service that provides a 2D map and/or a service that provides real-time information, in addition to the service that provides the AR view 10 or the service that provides the 3D map 20, in order to display additional information on the external area 2020 in the AR view 10 and accordingly, may display the additional information together with the 3D map 20 in the AR view 10.

In this way, in some example embodiments, as the additional information, such as 2D map data, is meshed up, more abundant information on the external area 2020 may be provided on the AR view 10. Therefore, the user that uses the AR view 10 and the 3D map 20 may acquire necessary (or otherwise, useful) information even for the external area 2020 as well as the area 2010 represented by the 3D map 20. Therefore, more effective virtual visitation to the area 2010 may be enabled.

Description related to technical features described above with reference to FIGS. 1 to 19 may be applied to FIGS. 20 to 24 as is, so redundant description is omitted.

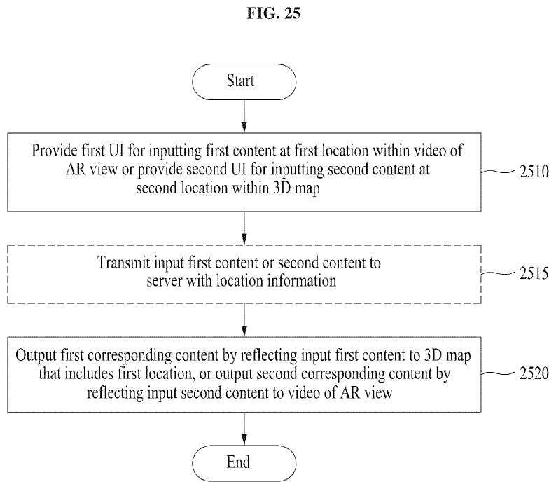

Hereinafter, a method and apparatus for providing a user interface that allows the user to input content for the video/3D map 20 displayed within the AR view 10 and reflecting and displaying (e.g., displaying corresponding content) the content input through the user interface to the 3D map 20 and/or the video displayed within the AR view 10 is described with reference to FIGS. 25 to 31.

In some example embodiments, a first UI may be provided that allows the user to input (e.g., create) content at a location selected within the video of the AR view 10, and the created content may be reflected to the 3D map 20 that includes the selected location as the corresponding content. Also, a second UI may be provided that allows the user to input (e.g., create) content at a location selected within the 3D map 20, and the created content may be reflected to the video of the AR view 10 that displays the selected location as the corresponding content.

FIG. 25 is a flowchart illustrating a method of controlling a user terminal to input first content in an AR view and output first corresponding content corresponding to the first content in a 3D map, or to input second content in the 3D map and output second corresponding content corresponding to the second content in the AR view according to some example embodiments.

In operation 2510, (1) the user terminal 100 may provide a first user interface (UI) for inputting first content at a first location selected within a video of the AR view 10 that includes the video captured by the camera of the user terminal 100. For example, the user may select (or touch) an arbitrary (or chosen, selected, etc.) location for inputting the first content in the video of the AR view 10. The first UI may be a UI for inputting at least one of audio, favorites, a bookmark, text, and/or an image (including a photograph and/or a moving picture) as the first content. Alternatively, the first UI may be a UI for inputting an action to be executed by the user terminal 100. Alternatively or additionally, (2) the user terminal 100 may provide the second user interface (UI) for inputting second content at a second location selected within the 3D map 20 augmented and displayed in the video within the AR view 10. For example, the user may select (or touch) an arbitrary (or chosen, selected, etc.) location for inputting the second content on the 3D map 20. The second UI may include a UI for inputting at least one of audio, favorites, a bookmark, text, and/or an image (including a photograph and/or a moving picture). Alternatively, the second UI may be a UI for inputting the action to be executed on the user terminal 100.

According to some example embodiments, in operation 2515, the user terminal 100 may transmit the input first content or the input second content to the server 200 along with information indicating the first location. According to some example embodiments, the server 200 may transmit the first content or the second content along with the information indicating the first location to at least one other user terminal.

In operation 2520, (1) if the first content is input through the first UI, the user terminal 100 may output first corresponding content corresponding to the first content when the 3D map 20 that includes the first location is displayed within the AR view 10. Therefore, the first content input in the video of the AR view 10 through the first UI may be reflected and output in the 3D map 20. (2) If the second content is input through the second UI, the user terminal 100 may output second corresponding content corresponding to the second content in the video of the AR view 10 that includes the second location. Therefore, the second content input from the 3D map 20 through the second UI may be reflected and output in the AR view 10.

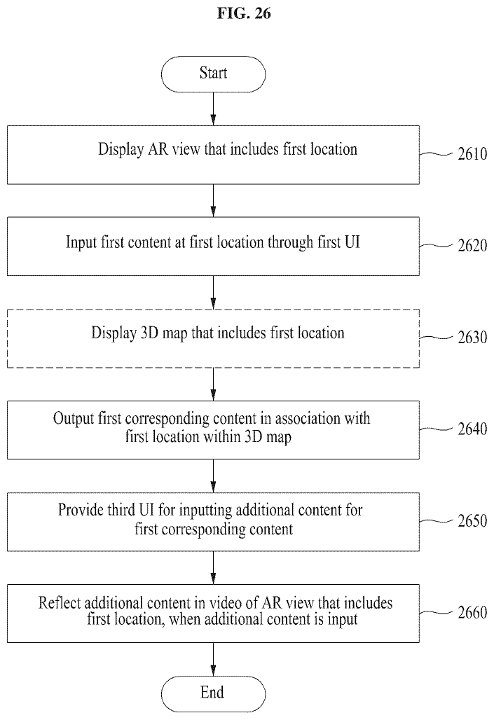

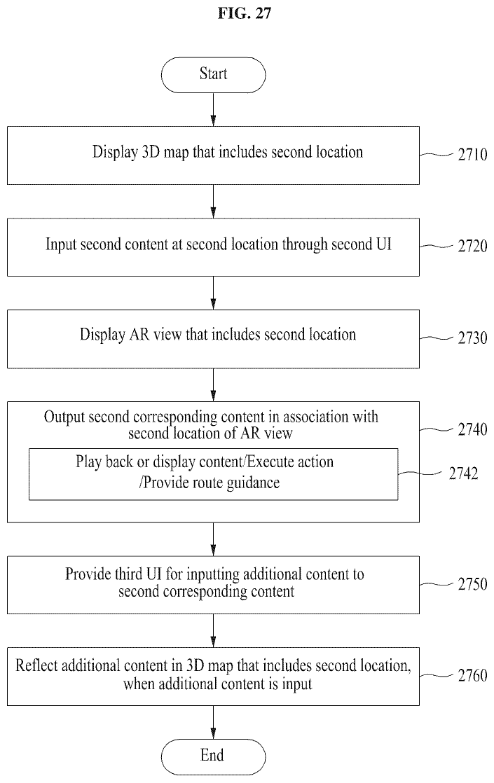

The example of (1) of the aforementioned operations 2510 and 2520 is further described with reference to FIG. 26 below, and the example of (2) is further described with reference to FIG. 27 below.

Description related to technical features described above with reference to FIGS. 1 to 24 may be applied to FIG. 25 as is, so redundant description is omitted.

FIG. 26 is a flowchart illustrating a method of controlling a user terminal to input first content in an AR view and output first corresponding content corresponding to the first content in a 3D map according to an example.

An example in which the first UI for inputting the first content at the first location within the AR view 10 is provided and the first content is input at the first location is further described with reference to FIG. 26.

In operation 2610, the user terminal 100 may display the AR view 10 that includes the video captured by a camera. The AR view 10 may include a first location.

In operation 2620, the user terminal 100 may receive the first content through the first UI at the first location.

The first location may be, for example, an arbitrary (or chosen, selected, etc.) location in the video of the AR view 10. Alternatively, the first location may be a location preset (or alternatively, given) to enable input of the first content in the video of the AR view 10. For example, the first location may be at least one of POIs displayed in the video, and the selected first location may correspond to a selected POI. Here, the first content may be any type of content input in association with the selected POI. Alternatively, the first location may correspond to an object displayed in the video or a selected location on the object. For example, the first location may include a building, a signboard of the building, a selected location on an exterior wall of the building, an entrance to the building, an entrance to parking lot of the building, etc.

The user may select (or touch) this first location within the video. Therefore, the user terminal 100 may call the first UI to provide an environment for the user to input the first content. For example, the first UI may be a UI for inputting at least one of audio, favorites, a bookmark, text, and/or an image as the first content. Alternatively, the first UI may be a UI for inputting an action to be executed on the user terminal 100.

In operation 2630, the user terminal 100 may display the 3D map 20 that includes the first location within the AR view 10 according to the location of the user terminal 100 or a request from the user of the user terminal 100. The request may be to display the 3D map 20 of the area that includes a user-specified location within the AR view 10.

In operation 2640, the user terminal 100 may output the first corresponding content in association with the first location within the 3D map 20 that includes the first location. For example, the first corresponding content may be output in association with the first location within the 3D map 20 that is the same as (or similar to) the first location at which the first content of the video of the AR view 10 is input, or an object within the 3D map 20 that includes the first location. The first corresponding content includes the input first content, which may be processed first content for output in association with the 3D map 20. For example, the first corresponding content may be processed to display the first content on the 3D map 20. Alternatively, the first corresponding content may be a type of content different from the first content. For example, when the first content is text, the first corresponding content may be audio content. This first corresponding content may be automatically output when the 3D map 20 that includes the first location is displayed in the AR view 10, or may be output from the user terminal 100 when the first location within the 3D map 20 or an object that includes the first location is selected, or when an icon or AR content within the 3D map 20 that represents the first corresponding content is selected.

The user terminal 100 may determine whether the user terminal 100 is located at the second location through positioning. When the user terminal 100 is located at the second location, the user terminal 100 may output the second corresponding content in association with the second location within the video of the AR view 10. When the second location is included in the video of the AR view 10, the user terminal 100 may be determined to be located at the second location based on positioning.

In this way, in some example embodiments, a location at which the second content is input on the 3D map 20 and a location within the AR view 10 determined through positioning may be linked (or synchronized). Therefore, the user may load the 3D map 20 that includes the second location and may create the second content at the second location without a need to directly visit the second location, and may move to the actual second location and may verify second corresponding content (corresponding to the created second content) through the AR view 10.

For example, the first content may include at least one of audio, favorites, a bookmark, text, and/or an image. For example, the first content may be at least a portion of a note or a checklist input for specific real estate or an object. Here, output of the first corresponding content may include at least one of playback of the audio, displaying of the text, and/or displaying of the image. That is, in some example embodiments, the user may verify the note or the checklist input by the user for specific real estate or an object through the video of the AR view 10 through the corresponding 3D map 20.

As another example, a route through which the user terminal 100 moves may be input as the first content through the first UI. In this example, the first location may be a starting point of the route through which the user terminal 100 moves. For example, the first UI or the user terminal 100 may record movement of the user terminal 100 from the first location that is the starting point of the route. The user terminal 100 may record movement of the user terminal 100 by recording location coordinates along which the user terminal 100 moves through positioning or by recording the AR view 10. The first UI may provide this recording. This recording may be terminated when the user terminal 100 reaches a predetermined (or alternatively, given) destination. For example, the recording may be terminated when the user inputs through the first UI that the destination is reached, or when the user inputs a request to stop recording through the first UI. Therefore, the input first content may include information on the route from the starting point to the destination.

The user terminal 100 may display the route from the starting point to the destination within the 3D map 20 that includes the first location (which is the starting point). Through this example, the user may verify an actual movement route through the corresponding 3D map 20 while viewing the AR view 10. The route may include a node (which represents a point designated by the user terminal 100 during movement or stayed by the user terminal 100 for a certain period of time) and an edge that connects nodes. This node and edge may be displayed on the 3D map 20.

In operation 2650, the user terminal 100 may further provide a third UI for inputting additional content for the first corresponding content displayed on the 3D map 20. The third UI may be a UI for inputting at least one of audio, favorites, a bookmark, text, and/or an image as the additional content. Alternatively, the third UI may be a UI for inputting an action to be executed on the user terminal 100.

In operation 2660, when the additional content is input through the third UI, the user terminal 100 may reflect the corresponding additional content in the AR view 10 that includes the first location. Therefore, the first content and the additional content may be output together in the video of the AR view 10 (or in association with the first location of the video).

For example, the user may enter a note at the first location while moving with viewing the video of the AR view 10 and then, upon return home, may display the 3D map 20 that includes the first location on the AR view 10 and may verify the note at the first location of the 3D map 20 on the AR view 10. Also, the user may further input an additional note for the note displayed at the first location of the 3D map 20. Then, when the user moves to the actual first location and includes the first location in the video of the AR view 10, the additional note may be displayed in association with the first location in the video in addition to the existing note.

Therefore, the user may organize and verify notes recorded while moving through actual space, executing the AR view 10, through the 3D map 20, and may also mark items that need to (or otherwise, should) be additionally verified as notes on the 3D map 20 and conveniently check them through the AR view 10 in actual space.

Description related to technical features described above with reference to FIGS. 1 to 25 may be applied to FIG. 26 as is, so redundant description is omitted.

FIG. 27 is a flowchart illustrating a method of controlling a user terminal to input second content in a 3D map and output second corresponding content corresponding to the second content in an AR view according to an example.

An example in which the second UI for inputting the second content at the second location within the 3D map 20 is provided and the second content is input at the second location is further described with reference to FIG. 27.

In operation 2710, the user terminal 100 may display the 3D map 20 that includes the second location within the AR view 10 according to a location of the user terminal 100 or a request from the user of the user terminal 100. An area represented by the 3D map 20 may include the second location.

In operation 2720, the user terminal 100 may receive the second content through the second UI at the second location.

The second location may be, for example, an arbitrary (or chosen, selected, etc.) location within the 3D map 20. Alternatively, the second location may be a location preset (or alternatively, given) to enable input of the second content within the 3D map 20. For example, the second location may be at least one of POIs displayed on the 3D map 20, and the selected second location may correspond to a selected POI. Alternatively, the second location may correspond to an object displayed on the 3D map 20 or a selected location on the object. For example, the second location may include a building, a signboard of the building, a selected location on an exterior wall of the building, an entrance to the building, an entrance to parking lot of the building, etc.

Here, the second content may be any type of content input in association with the selected POI or the selected location.

The user may select (or touch) this second location within the 3D map 20 and accordingly, the user terminal 100 may call the second UI to provide an environment for the user to input the second content. For example, the second UI may be a UI for inputting at least one of audio, favorites, a bookmark, text, and/or an image as the second content. Alternatively, the second UI may be a UI for inputting an action to be executed on the user terminal 100.

In operation 2730, the user terminal 100 may display the AR view 10 that includes the video captured by the camera. The AR view 10 may be executed in an environment that includes an actual second location and therefore, the second location may be included in the video of the AR view 10.

In operation 2740, if the second location is included in the video of the AR view 10, the user terminal 100 may output the second corresponding content in association with the second location within the video. For example, the second location within the video of the AR view 10 identical (or similar) to the second location at which the second content of the 3D map 20 is input, or the second corresponding content may be output in association with the object within the 3D map 20 that includes the corresponding second location. The second corresponding content includes the input second content, and may be processed second content for output associated with the video within the AR view 10. For example, the second corresponding content may be processed to display the second content in the video of the AR view 10. Alternatively, the second corresponding content may be a type of content different from the second content. For example, when the second content is text, the second corresponding content may be audio content. This second corresponding content may be automatically output when it is included in the video of the AR view 10 that includes the second location, or may be output from the user terminal 100 when the second location in the video of the AR view 10 or an object that includes the second location is selected, or when an icon or AR content within the video of the AR view 10 that represents the second corresponding content is selected.

The user terminal 100 may determine whether the user terminal 100 is located at the second location through positioning. When the user terminal 100 is located at the second location, the user terminal 100 may output the second corresponding content in association with the second location within the video of the AR view 10. When the second location is included in the video of the AR view 10, the user terminal 100 may be determined to be located at the second location based on positioning.

In this way, in some example embodiments, a location at which the second content is input on the 3D map 20 and a location within the AR view 10 determined through positioning may be linked (or synchronized). Therefore, the user may load the 3D map 20 that includes the second location and may create the second content at the second location without a need to directly visit the second location, and may move to the actual second location and may verify the second corresponding content (corresponding to the created second content) through the AR view 10.

For example, the second content may include at least one of audio, favorites, a bookmark, text, and/or an image. For example, the second content may be at least a portion of a note or a checklist input for specific real estate or object. Here, output of the second corresponding content may include at least one of playback of the audio, displaying of the text, and/or displaying of the image. That is, in some example embodiments, the user may mark items that need to (or otherwise, should) be checked in a real-world environment for specific real estate or object through the 3D map 20, and may move to the real-world environment and execute the AR view 10 to verify the notes through the video.

As another example, the second content may be a viewpoint or a perspective viewed by the user in the 3D map 20. An image of the 3D map 20 from this specific viewpoint or perspective may be captured and input as the second content.

The 3D map 20 that includes the second location may be displayed within the AR view 10 as a mini map of the area that includes the second location. This 3D map 20 may serve as auxiliary reference data for the user's movement. Also, as described above, the 3D map 20 may be displayed in full screen on the user terminal 100 to provide more immersive experience to the user.

In operation 2742, if the second location is included in the video of the AR view 10, the user terminal 100 may play back or display the content on the user terminal 100, may execute a predetermined (or alternatively, given) action, or may execute a function such as a route guidance (route guidance may also be an example of action).

An example of a case in which the second content includes a predetermined (or alternatively, given) action to be executed by the user terminal 100 is further described. In this case, if the second location is included in the video of the AR view 10, the user terminal 100 may execute the corresponding action on the user terminal 100.

Execution of the action on the user terminal 100 may include, for example, i) providing route guidance from a first point corresponding to the second location to a second point, ii) starting recording of the AR view 10, iii) interacting with an IoT device provided in association with the second location, iv) calling a specific contact of the user terminal 100, or v) providing real-time information associated with the second location. Alternately, the execution of the action may be execution of at least one of the aforementioned actions i) to v).

In i), the first point may be a starting point of the route, and the second point may be a destination of the route. For example, if the first point is an apartment entrance and the second point is a public transportation station or a school, an example may involve inputting a route guidance action at the apartment entrance within the 3D map 20 and, when the AR view 10 is executed at an actual apartment entrance, providing route guidance from the apartment entrance to the public transportation station or the school.

In ii), recording of the AR view 10 may be recording the video of the AR view 10 or recording the movement of the user terminal 100. When the AR view 10 is executed and the second location is included in the video, this recording of the AR view 10 may start.

In iii), interaction with the IoT device may be interaction with the IoT device provided in a real-world environment around the second location. For example, when the real-world environment is a construction site or a work site, the IoT device may be a device for calling a specific person. In this example, when the AR view 10 is executed and the second location is included in the video, the user terminal 100 may interact with the IoT device and accordingly, a task of calling the specific person may be performed. The IoT device may be a lighting device or an audio device and accordingly, when the AR view 10 is executed and the second location is included in the video, the user terminal 100 may be controlled to operate the lighting device or the audio device.

In iv), calling a specific contact of the user terminal 100 may be requesting a call or sending a message to a specific contact stored in the user terminal 100, a specific phone number, or a specific user (friend) registered to a messenger application. For example, a user that visits an area for a real estate transaction may execute the AR view 10 to automatically contact a real estate agency upon arrival at the specific second location, through some example embodiments.

In v), real-time information may include at least one of weather information, traffic information, and/or air quality information of the area associated with the second location. The real-time information may be acquired from an external map service or a separate external service that provides this real-time information. In some example embodiments, the user visiting the area may mark a point of which air quality information or traffic information needs to (or otherwise, should) be verified on the 3D map 20 through and, when the user actually moves to the point, may verify the air quality information or the traffic information through the AR view 10.

An action corresponding to provision of the real-time information may be executed only when a time at which the second location is included in the video of the AR view 10 belongs to a preset (or alternatively, given or defined) time zone (or time period, such as a time period corresponding to a range of a times of day, one or more days of the week, etc.). This time zone may be set by the user or preset (or alternatively, given). For example, the action may be implemented to check the air quality when the second location is displayed in the video of the AR view 10 in the specific time zone, and to check the traffic when the second location is displayed in the video of the AR view 10 in another specific time zone. Real-time information described with reference to FIGS. 1 to 26 may further include sunlight amount information and noise information in addition to the aforementioned examples.

Hereinafter, a method of inputting a route through which the user terminal 100 moves as second content through the second UI is further described. In this example, the second location may be a starting point of a route designated on the 3D map 20 that includes the second location. For example, the second UI may be a UI for the user to input the route (e.g., at least a portion of the route) from the second location corresponding to the starting point of the route to the destination on the 3D map 20. Therefore, the input second content may include information on the route from the starting point to the destination.

At least a portion of the route may be specified by the user of the user terminal 100 through the second UI on the 3D map 20 that includes the second location. For example, the user may specify at least a portion of the route through an action of drawing a line or selecting a road on the 3D map 20 or an action of selecting or inputting at least one of the starting point and the destination.

Alternatively, as described above in relation to the 3D map 20, the 3D map 20 that includes the second location may be displayed on the user terminal 100 such that the user of the user terminal 100 may virtually explore (e.g., view) the area that includes the second location. For example, the user may virtually explore the area by moving around the zoomed-in 3D map 20 or may virtually explore the area using a screen touch. At least a portion of the route may be an automatically recorded route that is virtually navigated by the user on the 3D map 20 that includes the second location (e.g., tracked and stored route that is virtually navigated by the user). Therefore, although the user does not directly specify the route in the 3D map 20, the route virtually navigated by the user may be input as the second content.

When the second location corresponding to the starting point of the route is included in the video of the AR view 10, the user terminal 100 may provide a guidance for the route from the starting point corresponding to the second location to the destination within the video of the AR view 10. The route guidance may be performed through AR content displayed in the video of the AR view 10.

An additional example is described with reference to operations 2750 and 2760.

In operation 2750, the user terminal 100 may further provide a third UI for further inputting additional content to (or for) the second corresponding content output in association with the second location within the video of the AR view 10. According to some example embodiments, inputting additional content to the second corresponding content may include modifying or adding to the second corresponding content. The third UI may be a UI for inputting at least one of audio, favorites, a bookmark, text, and/or an image as the additional content. Alternatively, the third UI may be a UI for inputting an action to be executed on the user terminal 100.

In operation 2760, when the additional content is input through the third UI, the user terminal 100 may reflect the corresponding additional content in the 3D map 20 that includes the second location. That is, if the additional content is input to the user terminal 100 through the third UI, the user terminal 100 may output the additional content in association with the second content at the second location of the 3D map 20 that includes the second location when displaying the 3D map 20 that includes the second location. Therefore, the second content and the additional content may be output together in the 3D map 20 (or in association with the second location of the 3D map 20).

For example, the user may virtually input a note at the second location while virtually visiting the area through the 3D map 20 and then, may actually move to the area and execute the AR view 10 to explore the area. Here, the note may be verified through the second location in the video of the AR view 10. Also, the user may further input an additional note to the note displayed through the video of the AR view 10. When the user returns home and displays, on the user terminal 100, the 3D map 20 that includes the second location in the AR view 10, the additional note may be further displayed on the 3D map 20 in addition to the existing note.

Therefore, the user may verify the notes recorded on the 3D map 20 while moving through the actual space by executing the AR view 10, and may also organize and verify the notes recorded in the video of the AR view 10 through the 3D map 20 while moving through the actual space.

Description related to technical features described above with reference to FIGS. 1 to 26 may be applied to FIG. 27 as is, so redundant description is omitted.

The first location at which the first content is input and the second location at which the second content is input, described above, may be plural.

The proposed 3D map 20 (e.g., in which content that includes the first location and/second location is created) may be shared with another user terminal. That is, this 3D map 20 may be displayed on another user terminal according to a location of the other user terminal or a request from a user of the other user terminal. According to some example embodiments, the other user terminal may obtain the 3D map 20 from the server 200 (or from the user terminal 100 via the server 200), but some example embodiments are not limited thereto and the other user terminal may obtain the 3D map 20 directly from the user terminal 100. Therefore, the first corresponding content may be output in association with the first location within the 3D map 20 displayed on the other user terminal. Through this example, in a case in which a first user inputs the first content at the first location of the AR view 10, the first corresponding content corresponding to the first content may be output in the 3D map 20 when a second user displays the 3D map 20 that includes the corresponding first location on a user terminal of the second user. Similar description may be applied to the second content and the second corresponding content. In this way, in some example embodiments, content created for the video of the 3D map 20 and/or AR view 10 may be shared between users (e.g., between friends or family members).

For sharing of the content and content linkage between the AR view 10 and the 3D map 20, the user terminal 100 may transmit the first content input through the first UI to a cloud server together with 6 degree of freedom (6DoF) information of the first location. Also, the user terminal 100 may transmit the second content input through the second UI to the cloud server together with 6DoF information of the second location. The cloud server may be the aforementioned server 200. Since the first location and the second location may have 3D spatial information (e.g., including height, rotation information, etc.), content linkage between the AR view 10 and the 3D map 20 may be performed in a more sophisticated manner. For example, the first content input at the first location of the video of the AR view 10 may be reflected as the first corresponding content at the (more accurate) first location of the 3D map 20 in consideration of 3D spatial information of the first location. That is, positioning between the AR view 10 and the 3D map 20 may be more accurately linked.

A positioning system for linking (or connecting) the location within the 3D map 20 and the location in the actual space may be implemented on the cloud server. For example, through this positioning system, a location (e.g., location at which content is created) on the 3D map 20 may be linked to the location in the actual space (or location in the AR view 10) indicating the corresponding location. Therefore, the location in the actual space according to positioning of the user terminal 100 may be linked with the location on the proposed 3D map 20. In this way, through linkage between the location on the 3D map 20 and the location in the actual space, content or an action input at one location on the 3D map 20 may be output at a corresponding location in the actual space.

The 3D map 20 is a 3D model of space (environment) and may be reconstructed based on the space mapping results. Based on the space mapping results, a Simultaneous Localization and Mapping (SLAM) map for positioning the space may be created. Also, the 3D map 20 may be configured to include positioning information in a top-down direction. Therefore, the 3D map 20 may be implemented such that the user may experience a more realistic virtual tour or exploration. Therefore, the content linkage between the AR view 10 and the 3D map 20 may be performed in a more sophisticated manner.

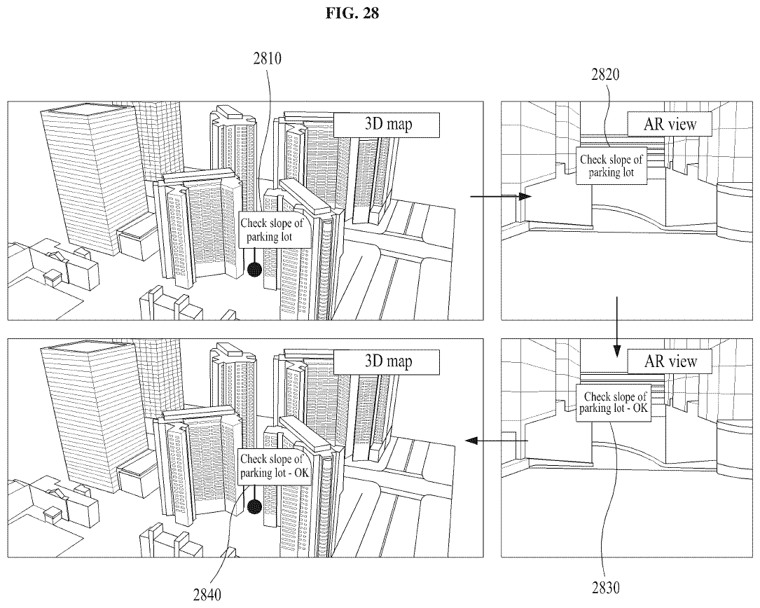

Hereinafter, a detailed example of content linkage between the AR view 10 and the 3D map 20 is further described with reference to FIGS. 28 to 31.

FIG. 28 illustrates a method of verifying (or confirming) content created at a specific location of a 3D map in an AR view including the specific location and reflecting the content verified (or confirmed) in the AR view to the 3D map according to an example.

A first picture of FIG. 28 exemplifies a case in which a note 2810 “Check slope of parking lot” is registered as the second location (e.g., entrance to parking lot of apartment complex) of the 3D map 20. In this way, the user may identify a location and an item to be verified in the actual field through the 3D map 20 and may leave a note in the 3D map 20.

A second picture of FIG. 28 exemplifies a case in which the second location (e.g., entrance to parking lot of apartment complex) is included in the video of the AR view 10. Here, a note “Check slope of parking lot” (e.g., second corresponding content) 2820 input in the first photo may be displayed in the video of the AR view 10. Therefore, the user may verify the slope of the actual parking lot entrance without forgetting through the note 2820.

A third picture of FIG. 28 exemplifies a case in which additional content is further input in addition to the note “Check slope of parking lot” (e.g., second corresponding content) 2820 output from the video of the AR view 10. That is, a note “Check slope of parking lot—OK” (e.g., second corresponding content) 2830 further includes the additional content “—OK” indicating that the slope of the actual parking lot entrance has actually been checked.

A fourth picture of FIG. 28 exemplifies a case in which the additional content is further included in a note 2840 displayed at the second location (e.g., entrance to parking lot of apartment complex) of the 3D map 20. In this way, the additional content “—OK” indicating that the slope of the actual parking lot entrance has actually been checked may be reflected in the 3D map 20.

As described above, the 3D map 20 may be shared with a user terminal of another user, and accordingly, the other user may also verify reflection of this additional content or creation of the second content through the 3D map 20.

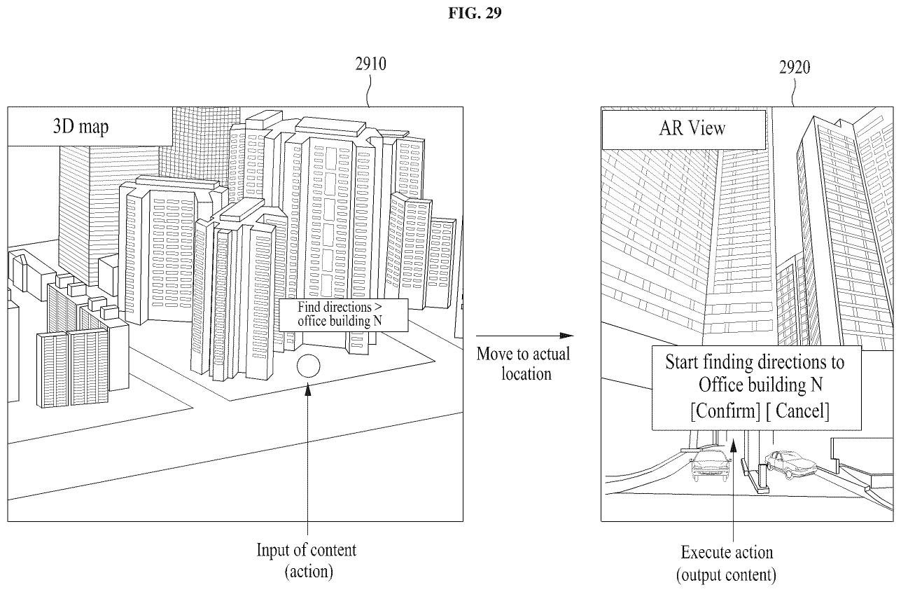

FIG. 29 illustrates a method of inputting an action to be executed by a user terminal as second content at a specific location of a 3D map and allowing the user terminal to execute the action when the specific location is included in an AR view according to an example.

FIG. 29 exemplifies a case in which an “action” executed by the user terminal 100 is provision of route guidance. For example, as illustrated, an action for performing route guidance from a corresponding selected point (second location, entrance to parking lot) to a specific destination (office building N) may be input as the second content on the 3D map 20 (2910). When the user terminal 100 moves to the second location and the second location is included in the AR view 10 (2920), the user terminal 100 may provide route guidance from the corresponding second location to the destination.

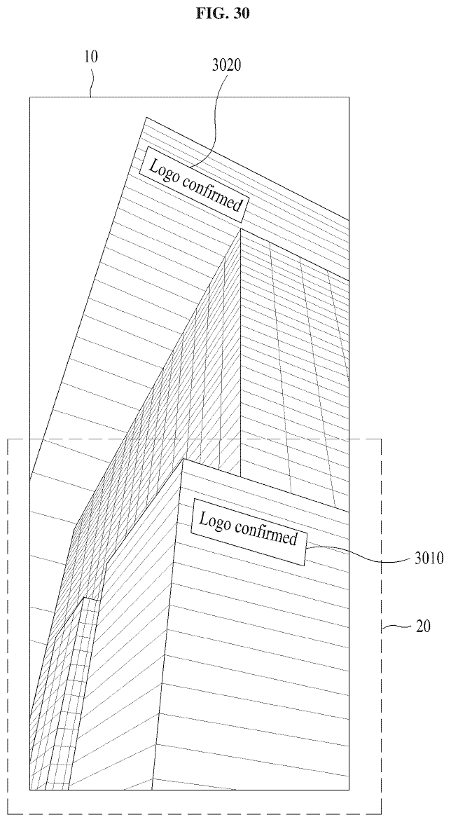

FIG. 30 illustrates a method of displaying a 3D map including a current location of a user terminal within an AR view that includes a video captured at the current location according to an example.

In FIG. 30, the 3D map 20 of an area that includes a current location of the user terminal 100 is displayed within the AR view 10. As illustrated, the same building (or a similar building) is displayed in the video of the AR view 10 and the 3D map 20. A note (second content) “Logo confirmed” 3010 may be input as second content at a signboard location of the building of the 3D map 20. Therefore, “Logo confirmed” (second corresponding content) 3020 may be displayed in the same way (or a similar way) in the same building (or a similar building) in the video of the AR view 10. When the second content is input, 3D spatial information of the input second location may also be transmitted to the server 200, the second corresponding content may be displayed at an exact location (or approximate location) corresponding to the second location in the video of the AR view 10.

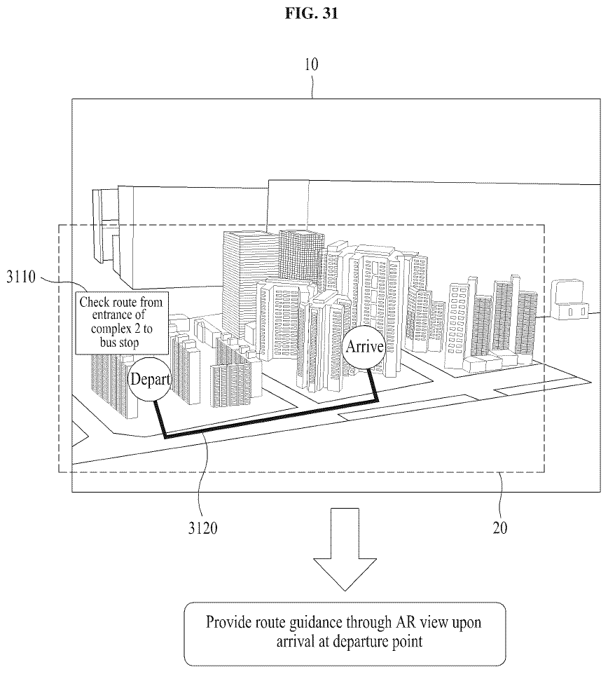

FIG. 31 illustrates a method for a user terminal to guide an input route when the route is input as second content at a specific location of a 3D map and the specific location is included in an AR view according to an example.

In an illustrated example, a note “Check route from entrance of complex 2 to bus stop” 3110 and a route 3120 are input as second content at a starting point (second location) of the route in the 3D map 20. This input of route and note may be performed before the user visits an actual area. When the user moves to an actual location corresponding to the starting point and executes the AR view 10 on the user terminal 100, the note “Check route from entrance of complex 2 to bus stop” and route guidance to the destination may be provided as second corresponding content.

The specified route may further include a plurality of waypoints in addition to the destination (not illustrated). When the user terminal 100 reaches a waypoint, the AR view 10 may output AR content indicating that the waypoint is reached.

An AR-to-AR content creation system between the AR view 10 and the 3D map 20 may be implemented according to a content interaction method between the AR view 10 and the 3D map 20 described with reference to FIGS. 25 to 31.

Description related to technical features described above with reference to FIGS. 1 to 27 may be applied to FIGS. 28 to 31 as is, so redundant description is omitted.

The AR view 10 and the 3D map 20 of some example embodiments described above with reference to FIGS. 1 to 31 may be utilized for virtual visitation, virtual tour, travel planning, construction/worksite management, and the like.

Existing devices and methods for providing an Augmented Reality (AR) display provide AR route guidance. However, the existing devices and methods are unable to display a sufficient amount of information in an intuitive and immersive form. For example, AR displays have limited display space for visualizing information and failure to efficiently use this limited display space results in insufficient visualization of information. Also, display of information in an overly dense manner results in user difficulty in receiving the information.

However, according to some example embodiments, improved devices and methods are provided for controlling an AR display. For instance, the improved devices and methods may involve displaying a 3D map of an area in an orientation matching an orientation of an AR view, thereby enabling a more intuitive and immersive display of the information contained in the 3D map. Additionally or alternatively, the improved devices and methods may involve displaying additional information on an external area outside of the 3D map, thereby enabling visualization of information beyond the 3D map while maintaining the intuitive and immersive display of the information. Additionally or alternatively, the improved devices and methods may involve enabling interaction with objects (e.g., real estate) displayed in the 3D map to provide access to additional content related to the objects, thereby providing an intuitive and abundant explanation of the objects. Additionally or alternatively, the improved devices and methods may involve enabling a user to add content (e.g., notes) to the 3D map and/or AR view that appear based on the user moving to a location corresponding to the content, thereby enabling better organization of displayed information and improved user engagement with the information.

In view of the above, the improved devices and methods overcome the deficiencies of the conventional devices and methods to at least provide a greater amount of information in an intuitive and immersive form. Also, the improved devices and methods provide for a more efficient use of the limited display space in the AR view while enabling a user to receive this information with less difficulty at least in view of the intuitive and immersive form by with the information is displayed.

The apparatuses described herein may be implemented using hardware components, software components, and/or the combination of the hardware components and the software components. For example, the apparatuses and the components described herein may be implemented using one or more general-purpose or special purpose computers, such as, for example, a processor, a controller, an Arithmetic Logic Unit (ALU), a digital signal processor, a microcomputer, a Field Programmable Gate Array (FPGA), a Programmable Logic Unit (PLU), a microprocessor or any other device capable of responding to and executing instructions in a defined manner. A processing device may run an Operating System (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, virtual equipment, non-transitory computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable storage mediums.

The methods according to some example embodiments may be recorded in non-transitory computer-readable media including program instructions executable through various computer methods. Here, the media may continuously store computer-executable programs or may transitorily store the same for execution or download. Also, the media may be various types of recording devices or storage devices in a form in which one or a plurality of hardware components are combined. Without being limited to a media directly connected to a computer system, the media may be distributed over the network. Examples of non-transitory computer-readable media include magnetic media such as hard disks, floppy disks, and magnetic tapes; optical media such as CD ROM disks and DVD; magneto-optical media such as floptical disks; and hardware devices that are specially designed to store and perform program instructions, such as Read-Only Memory (ROM), Random Access Memory (RAM), flash memory, and the like. Examples of other media may include recording media and storage media managed by an app store that distributes applications or a site, a server, and the like that supplies and distributes other various types of software.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with some example embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Although some example embodiments are described with reference to some specific examples and accompanying drawings, it will be apparent to one of ordinary skill in the art that various alterations and modifications in form and details may be made in these examples without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents.

Some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. As used herein the term “and/or” includes any and all combinations of one or more of the associated listed items.

Spatially relative terms, such as “beneath,” “below,” “lower,” “above,” “upper” and the like, may be used herein for ease of description to describe one element or feature's relationship to another element(s) or feature(s) as illustrated in the figures. For example, as used herein, the terms “upper,” “higher,” “on” and/or “top” may refer to an element or feature further in a given direction with respect to another element or feature, and the terms “lower” and/or “below” may refer to an element or feature further in a direction opposite the given direction with respect to another element or feature. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

Therefore, other implementations, other examples, and equivalents of the claims are to be construed as being included in the claims.

What is claimed is:

1. A method of controlling a user terminal, performed by a computer system that is a server or the user terminal, the method comprising:
providing a first User Interface (UI) for inputting first content created by a user of the user terminal at a first location selected within a video of an Augmented Reality (AR) view that includes a video captured by a camera of the user terminal, or providing a second UI for inputting second content created by the user at a second location selected within a three-dimensional (3D) map that is augmented and displayed in the video within the AR view; and
if the first content is input by the user through the first UI, reflecting and first outputting first corresponding content corresponding to the first content in the 3D map when the 3D map that includes the first location is displayed within the AR view, or if the second content is input by the user through the second UI, reflecting and second outputting second corresponding content corresponding to the second content in the video of the AR view that includes the second location.

2. The method of claim 1, further comprising:
in a case in which the first UI is provided and the first content is input at the first location, displaying the 3D map that includes the first location within the AR view according to a location of the user terminal or a request from the user of the user terminal,
wherein the first outputting comprises outputting the first corresponding content in association with the first location within the 3D map that includes the first location.

3. The method of claim 2, wherein
the first content includes at least one of audio, text, or an image; and
the first outputting of the first corresponding content includes at least one of playback of the audio, displaying of the text, or displaying of the image.

4. The method of claim 2, wherein
the 3D map that includes the first location is displayed on another user terminal according to a location of the other user terminal or a request from a user of the other user terminal; and
the first corresponding content is output in association with the first location within the 3D map displayed on the other user terminal.

5. The method of claim 2, wherein
the first location corresponds to a Point of Interest (POI) selected from among POIs displayed in the video; and
the first content is input in association with the selected POI.

6. A method of controlling a user terminal, performed by a computer system that is a server or the user terminal, the method comprising:
providing a first User Interface (UI) for inputting first content at a first location selected in a video of an Augmented Reality (AR) view that includes a video captured by a camera of the user terminal, or providing a second UI for inputting second content at a second location selected in a three-dimensional (3D) map that is augmented and displayed in the video within the AR view; and
if the first content is input through the first UI, first outputting first corresponding content corresponding to the first content when the 3D map that includes the first location is displayed within the AR view, or if the second content is input through the second UI, second outputting second corresponding content corresponding to the second content in the video of the AR view that includes the second location,
wherein
the method further comprises, in a case in which the first UI is provided and the first content is input at the first location, displaying the 3D map that includes the first location within the AR view according to a location of the user terminal or a request from a user of the user terminal,
the first outputting comprises outputting the first corresponding content in association with the first location within the 3D map that includes the first location,
the first location is a starting point of a route through which the user terminal moves,
the first content includes information on the route from the starting point to a predetermined destination, and
the first outputting comprises displaying the route from the starting point to the predetermined destination within the 3D map that includes the first location.

7. A method of controlling a user terminal, performed by a computer system that is a server or the user terminal, the method comprising:
providing a first User Interface (UI) for inputting first content at a first location selected in a video of an Augmented Reality (AR) view that includes a video captured by a camera of the user terminal, or providing a second UI for inputting second content at a second location selected in a three-dimensional (3D) map that is augmented and displayed in the video within the AR view; and
if the first content is input through the first UI, first outputting first corresponding content corresponding to the first content when the 3D map that includes the first location is displayed within the AR view, or if the second content is input through the second UI, second outputting second corresponding content corresponding to the second content in the video of the AR view that includes the second location,
wherein
the method further comprises displaying the 3D map that includes the second location within the AR view according to a location of the user terminal or a request from a user of the user terminal,
the second content is input in association with the second location through the second UI, and
the second outputting comprises outputting the second corresponding content in association with the second location in the video of the AR view when the second location is included in the video of the AR view.

8. The method of claim 7, wherein the 3D map that includes the second location is displayed within the AR view as a mini map of an area that includes the second location.

9. The method of claim 7, wherein
the second content includes at least one of audio, text, or an image; and
the second outputting of the second corresponding content includes at least one of playback of the audio, displaying of the text, or displaying of the image.

10. The method of claim 7, wherein
the second content includes a predetermined action to be executed by the user terminal; and
the second outputting comprises executing the predetermined action on the user terminal when the second location is included in the video of the AR view.

11. The method of claim 10, wherein the executing of the predetermined action comprises:
providing route guidance from a first point corresponding to the second location to a second point;
starting recording of the AR view;
interacting with an Internet of Things (IoT) device provided in association with the second location;
calling a specific contact of the user terminal; or
providing real-time information associated with the second location.

12. The method of claim 11, wherein the real-time information includes at least one of weather information, traffic information, or air quality information of an area associated with the second location.

13. The method of claim 11, wherein the predetermined action corresponding to the providing of the real-time information is executed when a time at which the second location is included in the video of the AR view belongs to a preset time zone.

14. The method of claim 11, wherein the interacting with the IoT device includes a task of calling a specific person through the IoT device.

15. The method of claim 7, wherein
the second location includes a starting point of a route designated on the 3D map that includes the second location;
the second content includes information on the route from the starting point to a predetermined destination; and
the second outputting comprises providing guidance for the route from the starting point corresponding to the second location to the predetermined destination, within the video of the AR view.

16. The method of claim 15, wherein at least a portion of the route is designated by the user of the user terminal on the 3D map that includes the second location.

17. The method of claim 15, wherein
the 3D map that includes the second location is displayed on the user terminal such that the user of the user terminal virtually explores an area that includes the second location; and
at least a portion of the route is an automatically recorded route that is virtually explored by the user on the 3D map that includes the second location.

18. The method of claim 7, wherein
the second location corresponds to a Point of Interest (POI) selected from among POIs displayed on the 3D map that includes the second location, or the second location corresponds to a selected location on an object displayed on the 3D map that includes the second location; and
the second content is input in association with the selected POI or the selected location.

19. The method of claim 9, further comprising:
providing a third UI for inputting additional content to the second corresponding content that is output in association with the second location within the video of the AR view, and
if the additional content is input through the third UL, outputting the additional content in association with the second content at the second location of the 3D map that includes the second location when displaying the 3D map that includes the second location.
